(19) United States
(12) Patent Application Publication
(10) Pub. No.: US 2006/0004218 A1
(43) Pub. Date: Jan. 5, 2006

(54) Binuclear transition metal complexes

(76) Inventor: Michael Arndt-Rosenau, Dormagen (DE)

Correspondence Address: LANXESS CORPORATION, 111 RIDC PARK WEST DRIVE, PITTSBURGH, PA, 15275-1112, US

(21) Appl. No.: 11/135,999

(22) Filed: May 24, 2005

(30) Foreign Application Priority Data
May 27, 2004 (DE) 1020040259380

(51) Int. Cl. C07F 15/04

(52) U.S. Cl. 556/33

(57) ABSTRACT

The invention relates to compounds having two metal centres, a process for preparing them, the use of the compounds as catalysts, a process for preparing homopolymers, copolymers and oligopolymers using these compounds, polymers obtainable from olefinic monomers and the compounds, the use of the polymers for shaped parts of all types and also shaped parts obtainable from these polymers.

The invention relates to compounds having two metal centres, a process for preparing them, the use of the compounds as catalysts, a process for preparing homopolymers, copolymers and oligopolymers using these compounds, polymers obtainable from olefinic monomers and the compounds, the use of the polymers for shaped parts of all types and also shaped parts obtainable from these polymers.

There is a great need for multinuclear compounds which display a particularly high activity in the polymerization of olefins compared to conventional catalysts.

Bull. Chem. Soc. Jpn. 62 (1989), 1325-1327 M. Jacob et al. describe the synthesis of iron complexes derived from phenylenediamines and pyridinecarbaldehyde. They were able to show that the use of para-phenylenediamine and meta-phenylenediamine gives binuclear complexes which catalyze the catalytic epoxidation of norbornene better than the corresponding mononuclear structure formed when using ortho-phenylenediamine. No experiments on the catalysis of polymerizations were carried out. In contrast to the compounds of the invention, the two iron centres are linked to one another by means of two ligands in the experiments described by Jacob et al.

In Chem. Rev. 216-217 (2001), 195-223, R. Ziessel et al. describe the formation of supramolecular aggregates using dipyridinealdehydes, oligopyridinealdehydes and polypyridinealdehydes having imine functions. In their compounds, too, the metal centres are linked to one another by means of at least two of the ligands.

A comparison of a mononuclear and a binuclear pyridylimine complex of palladium ([N-dodecylpyridyl-2-methanimine]palladium dichloride and ({[N,N′-μ-1,2-dodecanediyl]bis[pyridyl-2-methanimine]}palladium dichloride), in which the bridging of the pyridylimine units occurs via an alkyl chain and an electronic interaction between the two metal centres can therefore not occur, is described by R. Chen et al. in J. Mol. Catal. A: Chem. 193 (2003), 3340. The complexes were tested in comparison in the polymerization of ethene and it was found that the binuclear complex has a lower polymerization activity.

In U.S. Pat. No. 2002/0082162, Y. Li et al. disclose the synthesis and use of polynuclear α-diimine-nickel complexes and their use as polymerization catalysts. In their case, the substructure units which complex the nickel centres are joined to one another by means of a group which represents a substituted hydrocarbon. The introduction of this group once again prevents electronic coupling of the catalytically active centres.

On the other hand, in Macromolecules 33 (2000), 657-659 and in J. Polym. Sci.: Part A: Polym. Chem. 40 (2002), 2637-2647 T. Kanbara et al. describe palladium and platinum complexes having poly(arylenediphosphine), poly(arylenediphosphine oxide) and poly(arylenediphosphine sulphide) ligands in which para-phenylene substituents join the phosphorus centres of the ligand to one another. The polymeric catalysts formed in this way do not display improved catalytic activities in organic coupling reactions compared to the corresponding mononuclear species.

It is therefore an object of the present invention to provide binuclear compounds which display a better catalytic activity in the oligomerization and polymerization of olefins than the analogous mononuclear compounds.

This object is achieved by compounds of the formula (I), 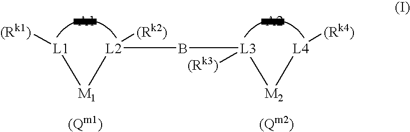
where
M₁ and M₂ can be identical or different and are selected independently from the group consisting of transition metals of groups 3 to 11 of the Periodic Table, Al and B and
L1, L2, L3, L4 can be identical or different and are selected independently from the group consisting of N, P, S, O, C, Si, Se, As and Sb and
A1 and A2 can be identical or different and are selected independently from among groups and/or atoms which can bridge the centres L1 to L2 and L3 to L4 via a covalent bond and can optionally contain further coordinating groups for M₁ and M₂ and
B is a group which electronically links the centres L2 and L3 to one another via covalent bonds and
m1 indicates the number and the difference of the individual ligands Q and can have any value from 1 to 6 and
m2 indicates the number and the difference of the individual ligands Q and can have any value from 1 to 6 and
Q is a group of from 1 to 6 ligands which are bound to M₁ and a group of from 1 to 6 ligands which are bound to M₂ where both the Q ligands which are bound to M₁ and the Q ligands which are bound to M₂ can be identical or different and are selected independently from the group consisting of monoanionic, dianionic and uncharged ligands, and
k1 indicates the number and the differences of the individual substituents R which are bound to L1 and can have any value from 0 to s¹−1, where s¹ is the valency of L1, and k2 indicates the number and the differences of the individual substituents R which are bound to L2 and can have any value from 0 to s²−2, where 52 is the valency of L2, and
k3 indicates the number and the differences of the individual substituents R which are bound to L3 and can have any value from 0 to s²−2, where s³ is the valency of L3, and
k4 indicates the number and the differences of the individual substituents R which are bound to L4 and can have any value from 0 to s⁴−1, where S4 is the valency of L4, and
R is a group of from 0 to s¹ −1 substituents which are bound to L1, a group of from 0 to s²−2 substituents which are bound to L2, a group of from 0 to s³−2 substituents which are bound to L3 and a group of from 0 to s⁴−1 substituents which are bound to L4, where these can be identical or different and are selected independently from the group consisting of hydride, C₁₋₂₀-alkyl groups, C₁₋₂₀-alkenyl groups, C₆₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical, —OD¹, —ND²D³, PD⁶D⁷D⁸ and −BD⁹D¹⁰
   where D¹ to D¹⁰ can be identical or different and are selected independently from the group consisting of H, C₁₋₂₀-alkyl groups, C₆₋₂₀-cycloalkyl groups, C₆₋₂₀-aryl groups, alkylaryl groups having C₁₋₂₀ groups in the alkyl radical and C₆₋₂₀ groups in the aryl radical and arylalkyl groups having C₁₋₂₀ groups in the alkyl radical and C₆₋₂₀ groups in the aryl radical.

Advantageous compounds according to the invention include compounds in which
L1, L2, L3 and L4 are identical or different and are selected independently from the group consisting of N, O, P and S.

Advantageous compounds include compounds of the formula (II), 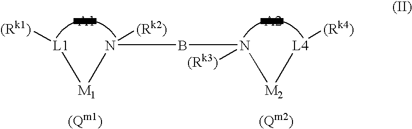
where L2 and L3 are nitrogen centres.

Advantageous compounds according to the invention include compounds in which
A1 and A2 are identical or different and are selected independently from the group consisting of saturated or unsaturated hydrocarbon radicals having from 1 to 20 carbon atoms, cyclic saturated or unsaturated hydrocarbon radicals having from 4 to 20 carbon atoms, heterocyclic saturated or unsaturated compounds having from 3 to 20 carbon atoms, nitrogen-containing groups, phosphorus-containing groups, silicon-containing groups, tin-containing groups, germanium-containing groups and boron-containing groups, where all these groups may bear further substituents.

Advantageous compounds include compounds of the formula (III), 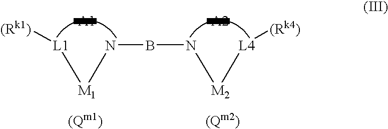
where L2 and L3 are nitrogen atoms which are bound via a double bond to the associated fragments A1 and A2.

Further advantageous compounds include compounds in which B is an aromatic or heteroaromatic group which may bear further substituents.

Advantageous compounds include compounds of the formula (IV), 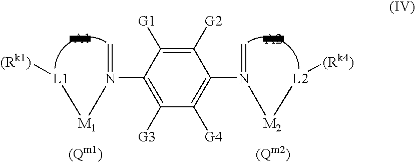
where L2 and L3 are nitrogen centres which are linked to A1 and A2 via a double bond and B is a para-substituted aromatic six-membered ring substituted by substituents
G1, G2, G3, G4 which are identical or different and selected from the group consisting of halide, hydride, C₁₋₂₀-alkyl groups, C₁₋₂₀-alkenyl groups, C₅₋₂₀-cycloalkyl groups, C₆₋₂₀-aryl groups, alkylaryl groups having C₁₋₂₀ groups in the alkyl radical and C₆₋₂₀ groups in the aryl radical, —OT¹, —OT¹T², —NT²T⁴, —NT⁵T⁶T⁷, —PT⁸T⁹, —PT¹⁰T¹¹T¹², where T¹ to T¹² are identical or different and are selected independently from the group consisting of H, C₁₋₂₀-alkyl groups, C₅₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical and arylalkyl groups having C₁₋₂₀ groups in the alkyl radical and C₆₋₂₀ groups in the aryl radical.

Advantageous compounds include compounds in which L1 is identical to L4 and the unsubstituted skeleton of A1 is identical to the unsubstituted skeleton of A2. 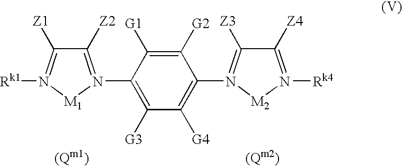
where
Z1, Z2, Z3, Z4 are identical or different and are selected independently from the group consisting of halide, hydride, C₁₋₂₀-alkyl groups, C₁₋₂₀-alkenyl groups, C₅₋₂₀-cycloalkyl groups, C₆₋₂₀-alkylaryl groups having C₁₋₂₀ groups in the alkyl radical and C₆₋₂₀ groups in the aryl radical, —OT¹, —OT¹T², —NT³T⁴, —NT⁵T⁶T⁷, —PT⁸T⁹ and —PT¹⁰T¹¹T ², where two adjacent Z substituents may together form a saturated or unsaturated ring which may bear further substituents.

Advantageous compounds include compounds of the formula (V) in which
R^{k1} and R^{k4} are, respectively, a group of from 1 to s²−2 substituents which are bound to L1 and a group of from 1 to s⁴−2 substituents which are bound to L4, where these are identical or different and are selected independently from the group consisting of unsaturated C₆₋₂₀ cyclic systems which may bear further substituents, where the substituents can be identical or different and are selected independently from the group consisting of halide, hydride, C₁₋₂₀-alkyl groups, C₁₋₂₀-alkenyl groups, C₅₋₂₀-cycloalkyl groups, C₆₋₂₀-alkylaryl groups having C₁₋₂₀ groups in the alkyl radical and C₆₋₂₄ groups in the aryl radical, —OT¹, —OT¹T², —NT³T⁴, —NT⁵T⁶T⁷, —PT⁸T⁹ and —PT¹⁰T¹¹T¹² and two adjacent substituents may together form a saturated or unsaturated ring which may bear further substituents.

Advantageous compounds according to the invention include compounds in which the substituents R of the groups R^{k1} and R^{k4} are in each case selected from the group consisting of substituted aryl and/or heteroaryl groups.

Advantageous compounds include compounds of the formula (V) in which
M₁ and M₂ are identical or different and are selected independently from the group consisting of Ti, Zr, Hf, V, Cr, Mo, W, Mn, Fe, Ru, Co, Rh, Ni, Pd, Pt, Cu, Zn, Al and B,
m1 indicates the number and the difference of the individual ligands Q and can have any value from 1 to 6 and
m2 indicates the number and the difference of individual ligands Q and can have any value from 1 to 6 and
Q is a group of from 1 to 6 ligands which are bound to M₁ and a group of from 1 to 6 ligands which are bound to M₂, where both the Q ligands which are bound to M₁ and the Q ligands which are bound to M₂ are selected independently from the group consisting of halide, hydride, C₁₋₂₀-alkyl groups, C₁₋₂₀-alkenyl groups, C₅₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical, OT¹, OT¹T², —NT³⁴, —NT⁵T⁶T⁷, —PT⁸T⁹, —PT¹⁰T¹¹T ², 1,2-alkanediyl compounds, 1,4-alkanediyl compounds, 1,5-alkanediyl compounds, 1,ω-alkanediyl compounds, dialkoxides, dithiolates, diamides, ethers, amines, phosphines, phosphine oxides, olefins, acetylenes, carbon monoxide, nitrogen (N₂), hydrogen (H₂), carbenes, nitrogen ylides, carbon ylides and phosphorus ylides.

Advantageous compounds include compounds of the formula (V) in which
M₁ and M₂ are identical or different and are selected independently from the group consisting of Ti, Zr, Hf, Fe, Ru, Co, Ni, Pd and Al.

An advantageous compound is the compound of the formula (VI)

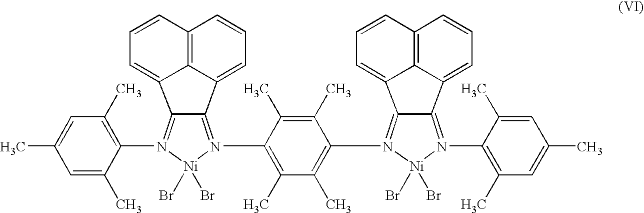

The invention further provides a process for preparing the compounds of the formula (I), which comprises the steps
a) preparation of a compound of the formula (VII), 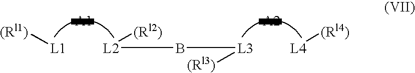
   where l1 is greater than or equal to k1, l2 is greater than or equal to k2, l3 is greater than or equal to k3 and l4 is greater than or equal to k4;
b) subsequent reaction of the compound of the formula (VII) either
   I) with a metal compound of the formula M₁(Q^{m1}) and further reaction with a metal compound of the formula M₂(Q^{m2}) or
   II) with a metal compound of the formula M₃(Q^{o3}), then reaction with a metal compound of the formula M₁(Q^{m1}) and further reaction with a metal compound of the formula M₂(Q^{m2}) or
   III) with a metal compound of the formula M₁(Q^{m1}), then reaction with a metal compound of the formula M₃(Q^{o3}) and further reaction with a metal compound of the formula M₂(Q^{m2}) or
   IV) with a metal compound of the formula M₃(Q^{o3}), then reaction with a metal compound of the formula M₁(Q^{m1}), then once again a reaction with a metal compound of the formula M₃(Q^{o3}) and further reaction with a metal compound of the formula M₂(Q^{m2}) or
   V) with a plurality of metal compounds of the formula M₃(Q^{o3}), then reaction with a metal compound of the formula M₄(Q^{o4}), subsequent reaction with a metal compound of the formula M₁(Q^{m1}) and subsequent reaction with a metal compound of the formula M₂(Q^{m2}) or
   VI) with a metal compound of the formula M₁(Q^{m1}), then reaction with a metal compound of the formula M₃(Q^{o3}), subsequent reaction with a metal compound of the formula M₄(Q^{o4}) and subsequent reaction with a metal compound of the formula M₂(Q^{m2}) or
   VII) with a metal compound of the formula M₃(Q^{o3}), then reaction with a metal compound of the formula M₄(Q^{o4}), then reaction with a metal compound of the formula M₁(Q^{m1}), subsequently reaction again with a metal compound of the formula M₃(Q^{o3}), then reaction again with a metal compound of the formula M₄(Q^{o4}) and subsequent reaction with a metal compound of the formula M₂(Q^{m2}),
   where o3 indicates the number and the differences of the individual ligands Q which are bound to M₃ and o3 is a number from 1 to 8 and o4 indicates the number and the differences of the individual ligands Q which are bound to M₄ and o4 is a number from 1 to 8 and
   M₃ and M₄ can be identical or different and are selected independently from the group consisting of transition metals of groups 3 to l1 of the Periodic Table, A1 and B.

The invention further provides for the use of the compounds of the invention as catalysts.

The compounds are advantageously used in the presence of Lewis acids or bases.

The invention further provides the intermediate obtainable by reacting one of the compounds of the invention with a Lewis acid or Lewis base.

The invention further provides a process for preparing homopolymers, copolymers and/or oligopolymers, in which the compounds of the invention or the intermediates are reacted with olefinic monomers.

In this process, the olefinic monomers are advantageously selected from the group consisting of ethene, propene, 1-butene, 2-butene, isobutene, 1-pentene, 2-pentene, 1-hexene, 2-hexene, 3-hexene, 1-heptene, 1-octene, 1-decene, 1-dodecene, cyclopentene, norbornene, styrene, p-methylstyrene, methyl acrylate, methyl methacrylate, vinyl acetate, acrylonitrile and methacrylonitrile or mixtures thereof.

The invention further provides the polymers obtainable by a process in which the compounds of the invention are used.

The invention further provides for the use of the polymers which have been prepared with the aid of the compounds of the invention for producing shaped parts of all types.

The invention further provides the shaped parts obtainable by processing of the polymers prepared with the aid of the compounds of the invention.

In the novel compounds of the formula (I), M₁ and M₂ are identical or different and are selected independently from the group consisting of transition metals of groups 3-11 of the Periodic Table, Al and B.

Preference is given to titanium, zirconium, hafnium, vanadium, chromium, molybdenum, tungsten, manganese, iron, ruthenium, cobalt, rhodium, nickel, palladium, platinum, copper, zinc, aluminium and boron.

Particular preference is given to titanium, zirconium, hafnium, iron, ruthenium, cobalt, nickel, palladium, copper, zinc and aluminium.

Very particular preference is given to titanium, zirconium, hafnium, iron, ruthenium, cobalt, nickel, palladium.

Nickel is especially preferred.

L1, L2, L3 and L4 are identical or different and are selected independently from the group consisting of N, P, S, O, C, Si, Se, As and Sb.

Preference is given to C, N, O, P and S.

L2 and L3 are particularly preferably nitrogen.

When L2 and L3 are N, then L1 and L4 are preferably selected from the group consisting of C, N, O, S and P.

A special preference is given to L1, L2, L3 and L4 all being nitrogen.

L1, L2, L3 and L4 may be substituted by further radicals R^{k1}, R^{k2}, R^{k3} and R^{k4}, where k1, k2, k3 and k4 represents a plurality, depending on the valency of L1, L2, L3 and L4, of identical and/or different substituents from the group of R substituents and these further substituents on R^{k1}, R^{k2}, R^{k3} and R^{k4} can be identical or different and are selected independently from the group consisting of hydride, C₁₋₂₀-alkyl groups, C₁₋₂₀-alkenyl groups, C₅₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical, —OD¹, —ND²D³, —PD⁶D⁷D¹ and —BD⁹D¹⁰, where D¹ to D¹⁰ can be identical or different and are selected independently from the group consisting of H, C₁₋₂₀-alkyl groups, C₅₋₂₀-cycloalkyl groups, C₆₋₂₀-aryl groups, alkylaryl groups having C₁₋₂₀ groups in the alkyl radical and C₆₋₂₀ groups in the aryl radical and arylalkyl groups having C₁₋₂₀ groups in the alkyl radical and C₆₋₂₀ groups in the aryl radical.

C₁₋₂₀-Alkyl groups are, for the purposes
of the present invention, all linear or branched
alkyl radicals having from 1 to 20 carbon atoms
which are known to those skilled in the art.
Preference is given to methyl, ethyl, n-
propyl, i-propyl, n-butyl, i-butyl, t-butyl,
n-pentyl, i-pentyl, neopentyl, hexyl,
heptyl, octyl, nonyl and decyl groups which
may in turn be substituted. Possible
substituents of the C₁₋₂₀-alkyl radicals
are all substituents known to those skilled
in the art for alkyl groups. Preferred
substituents are halogen, nitro groups,
hydroxyl groups, C₁₋₂₀-alkyl groups,
C₅₋₂₀-cycloalkyl groups, C₆₋₂₀-
aryl groups. Particularly preferred
substituents on the C₁₋₂₀-alkyl group
are benzoyl, trimethylphenyl, ethylphenyl,
chloromethyl, chloroethyl and nitromethyl.
C₁₋₂₀-Alkenyl groups are, for the purposes
of the present invention, all linear or branched
alkenyl radicals having from 1 to 20 carbon
atoms which are known to those skilled in the
art. Preference is given to methylidene,
ethylidene, propylidene and cyclohexenyl
groups.
C₅-C₂₀-Cycloalkyl groupsare, for
the purposes of the present
invention, all monocyclic or polycyclic
substituted and unsubstituted cycloalkyl
radicals having from 5 to 20 carbon atoms
which are known to those skilled in the
art. Preference is given to cyclopentyl,
cyclohexyl, cycloheptyl, cyclooctyl,
cyclononyl and partially or fully
hydrogenated fluorenyl, where all
cycloalkyls may in turn be substituted.
Possible substituents on the C₅₋₁₄-
cycloalkyls are all substituents known to
those skilled in the art for cycloalkyl
groups. Preferred substituents are halogen,
the nitro group, C₁₋₁₀-alkoxy groups,
C₁₋₁₀-alkyl groups, C₆₋₁₂-cycloalkyl
groups, C₆₋₁₂-aryl groups. Particularly
preferred substituents on the C₅-C₁₄-
cycloalkyl group are methylcyclohexyl,
chlorocyclohexyl and nitrocyclohexyl.
C₆₋₂₀-Aryl groups are, for the purposes of
the present invention, all monocyclic or polycyclic,
substituted and unsubstituted aryl radicals
having from 6 to 20 carbon atoms which are
known to those skilled in the art. Preference
is given to phenyl, naphthyl and fluorenyl,
which may in turn be substituted. Possible
substituents on the C₆₋₂₀-aryl groups are
all substituents known to those skilled in
the art for aryl groups. Preferred
substituents are halogen, the trifluoromethyl
group, the nitro group, C₁-C₂₀-alkoxy groups,
C₁₋₂₀-alkyl groups, C₅₋₂₀-cycloalkyl
groups, C₆₋₂₀-aryl groups. Particularly
preferred substituents on the C₆₋₂₀-aryl
group are the 3,5-dimethylphenyl, 4-tert-
butylphenyl, 4-methoxyphenyl, chloro, bromo,
methyl, ethyl, propyl, isopropyl, tert-butyl,
tolyl and nitrophenyl groups.
C₁₋₂₀-Heteroaryl groups are, for the
purposes of the present invention, all monocyclic
or polycyclic, substituted or unsubstituted
heterocyclic aromatics having from 1 to 20 carbon
atoms which are known to those skilled in the art.
Preference is given to thienylphenyl,
pyridyl, furanyl, pyranyl, thiazolyl,
pyrrolyl, oxazolyl, isoxazolyl, pyrazolyl,
imidazolyl, 1,2,3-triazolyl, 1,2,4-triazolyl,
benzofuranyl-, thianaphthenyl,
dibenzofuranyl, indolyl, benzimidazolyl,
indazolyl, quinolyl and isoquinolyl groups,
which may in turn bear further substituents.
Possible substituents on the C₁₋₂₀-heteroaryl
groups are all substituents known to those
skilled in the art for heteroaryl groups.
Preferred substituents are hydrogen, halogens,
the nitro group, C₁₋₂₀-alkoxy groups,
C₁₋₂₀-alkyl groups, C₁₋₂₀-heteroaryl groups,
C₅₋₂₀-cycloalkyl groups and C₆₋₂₀-aryl groups.
Particularly preferred substituents on the
C₁₋₂₀-heteroaryl group are the 2,4-
dimethylfuran-3-yl and N-methyl-2-
phenylpyrrol-4-yl groups.
Alkylaryl groups having C₁₋₂₀ groups in the
alkyl radical and C₆₋₂₀ groups in the aryl
radical are, for the purposes of the present
invention, all substituted and unsubstituted
alkylaryls having from 1 to 20 carbon atoms in
the alkyl radical and 6-20 carbon atoms in
the aryl radical which are known to those skilled
in the art. Preference is given to benzyl and
alkyl-substituted benzyl groups.
The C₁₋₂₀-alkyl groups, C₅₋₂₀-
cycloalkyl groups, C₆₋₂₀-aryl groups,
alkylaryl groups having C₁₋₂₀ groups
in the alkyl radical and C₆₋₂₀ groups
in the aryl radical and arylalkyl groups
having C₁₋₂₀ groups in the alkyl
radical and C₆₋₂₀ groups in the aryl radical
for the radicals D¹ to D¹⁰ in —OD¹, —ND²D³,
—PD⁶D⁷D⁸ and —BD⁹D¹⁰ are as defined above.
Particularly preferred compounds —OD¹ are the
methoxy, ethoxy, propoxy, isopropoxy,
butoxy, tert-butoxy, phenoxy, 2,6-
diphenylphenoxy, 2,6-dimethylphenoxy, 2,6-
dichlorophenoxy, 2,6-dibromophenoxy, 2,6-
diiodophenoxy groups, particularly preferred
compounds —ND²D³ are the dimethylamino,
diethylamino, diisopropylamino,
dipropylamino, dibutylamino, di-tert-
butylamino, diphenylamino, methylphenylamino,
ethylphenylamino, 2,6-dimethylanilino,
2,6-diethylanilino, 2,6-diisopropylanilino,
2,6-dichloroanilino, 3,5-dimethylanilino
groups, particularly preferred compounds
—PD⁶D⁷D⁸ are the tricyclohexylphosphino,
triphenylphosphino, tri-tertbutylphosphino,
triethylphosphino, trimethylphosphino,
dicyclohexylphosphino, diphenylphosphino
groups and particularly preferred compounds
—BD⁹D¹⁰ are the dichloroboranyl,
dimethylboranyl, diethylboranyl,
diphenylboranyl, bis(2,3,4,5,6-
pentafluorophenyl)boranyl, dihydroxyboranyl,
dimethoxyboranyl, diethoxyboranyl groups.

The groups R^{k1} and R^{k4} are preferably selected from the group consisting of substituted aryl and/or heteroaryl groups.

The groups R^{k1} and R^{k4} are very particularly preferably selected from the group consisting of the following substituted aromatics of the formulae 1 to 106, where the broken line indicates the point of linkage to L1, L2, L3 and/or L4:

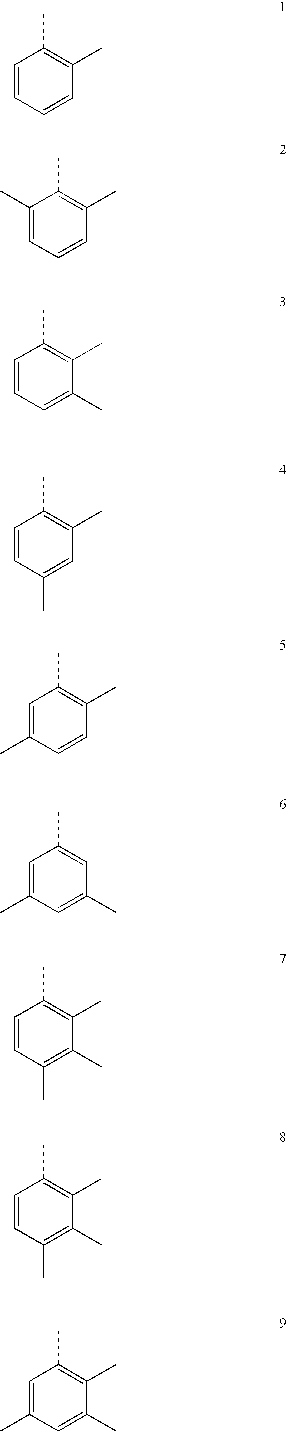

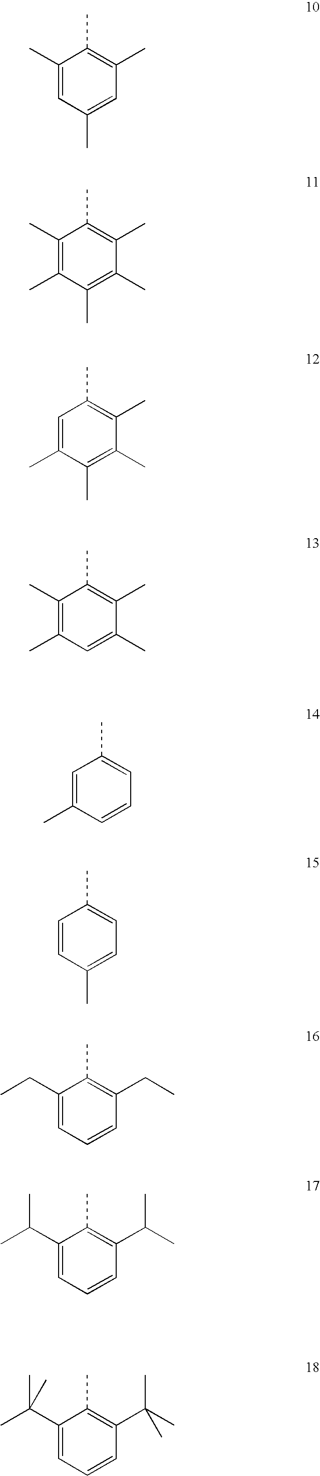

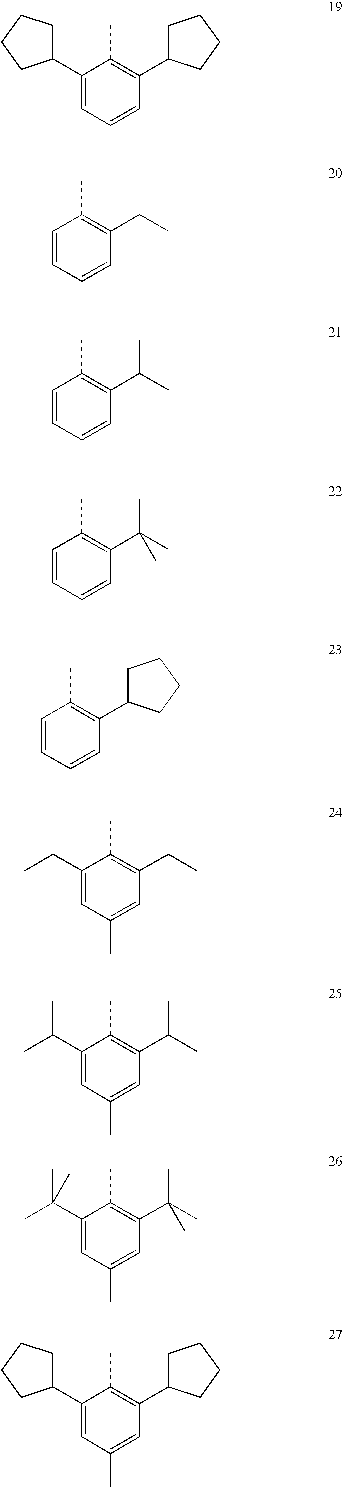

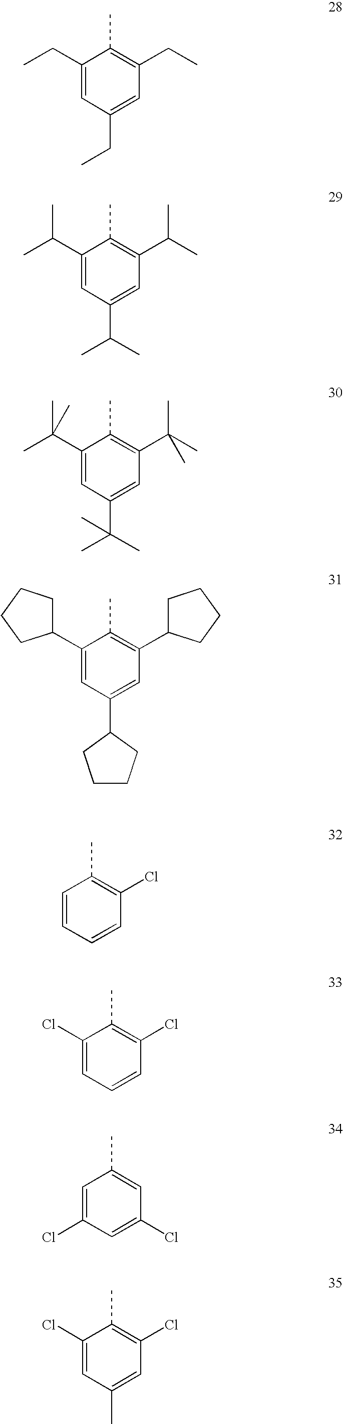

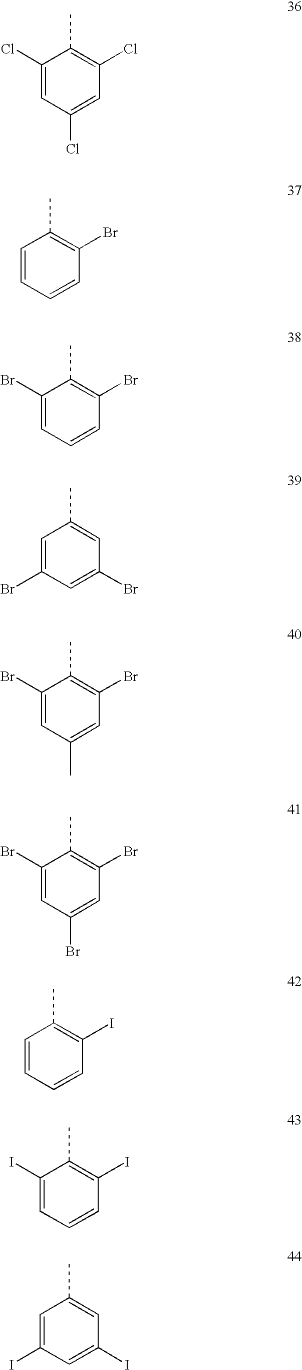

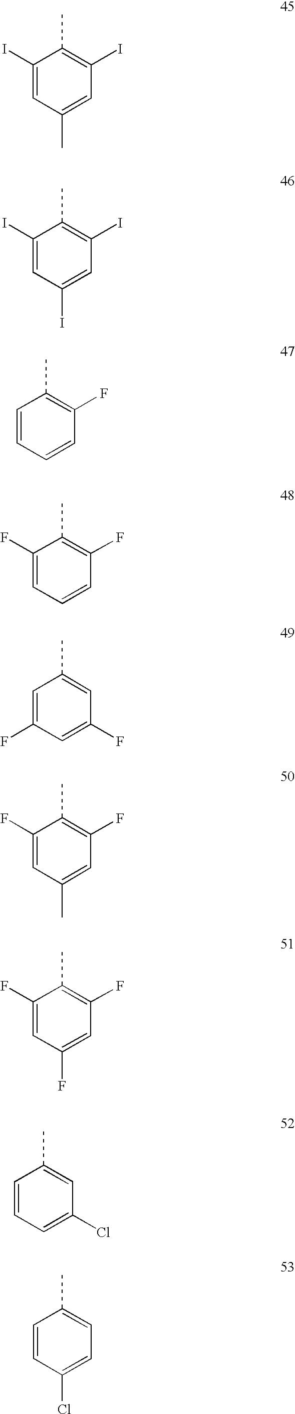

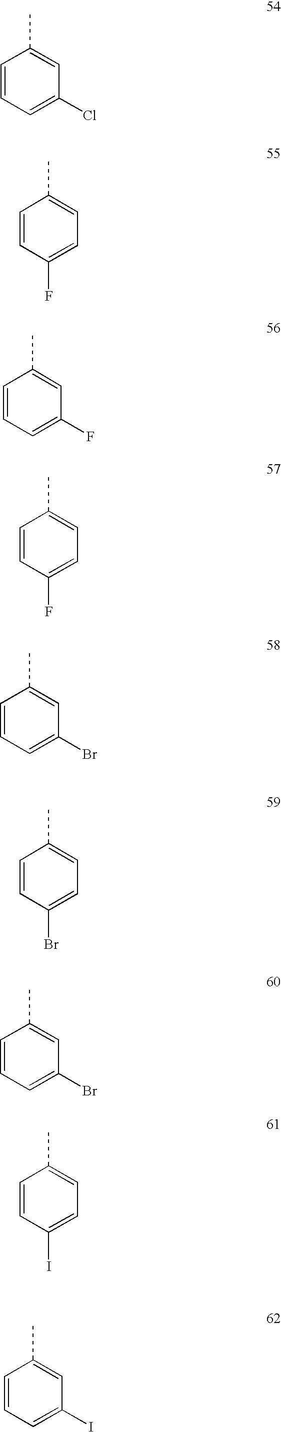

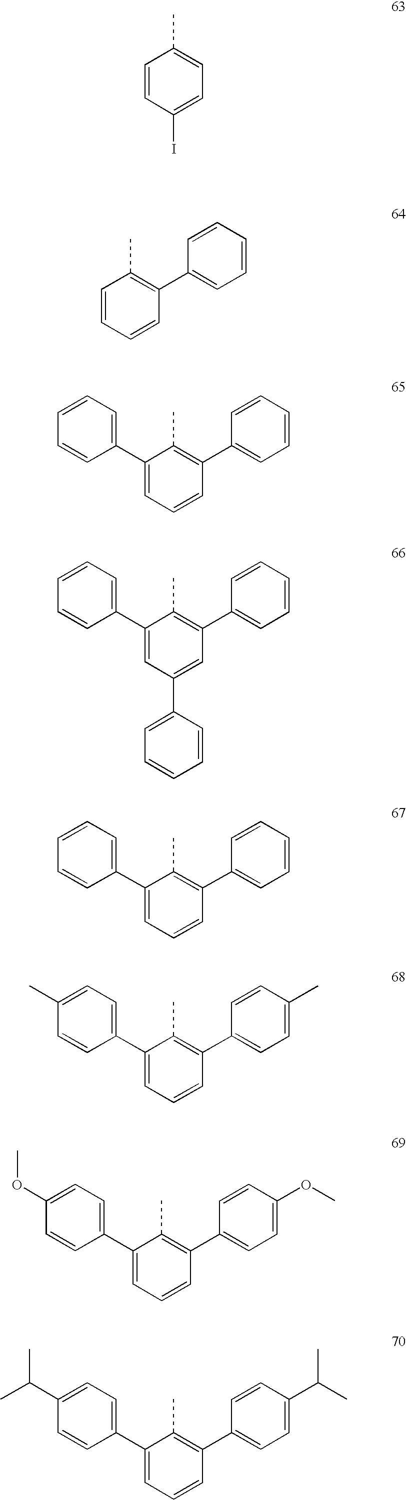

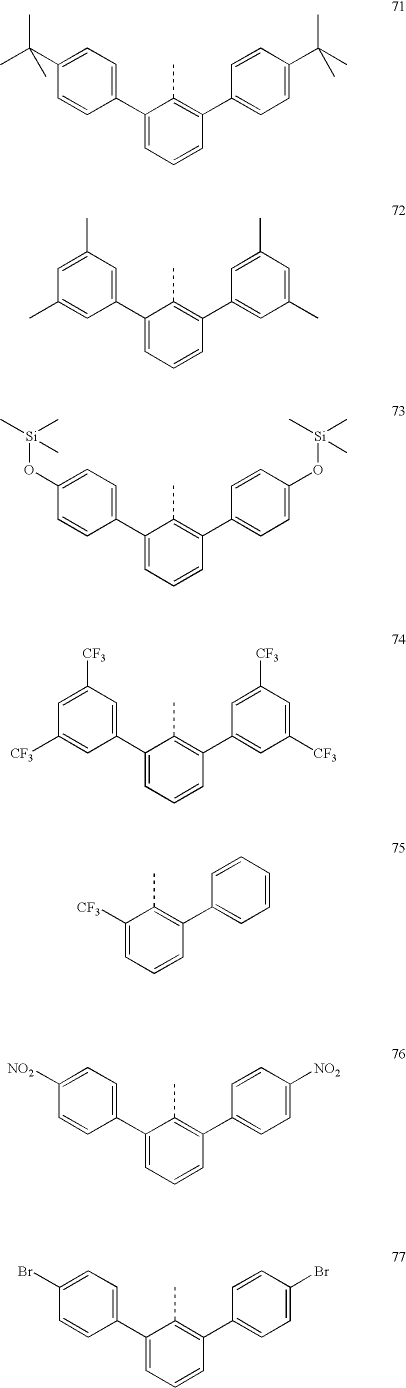

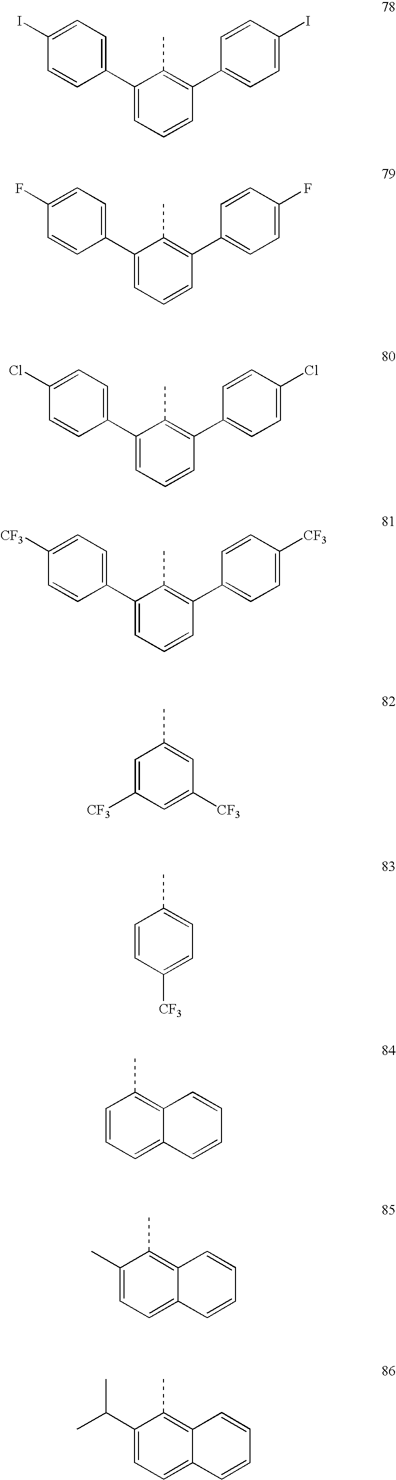

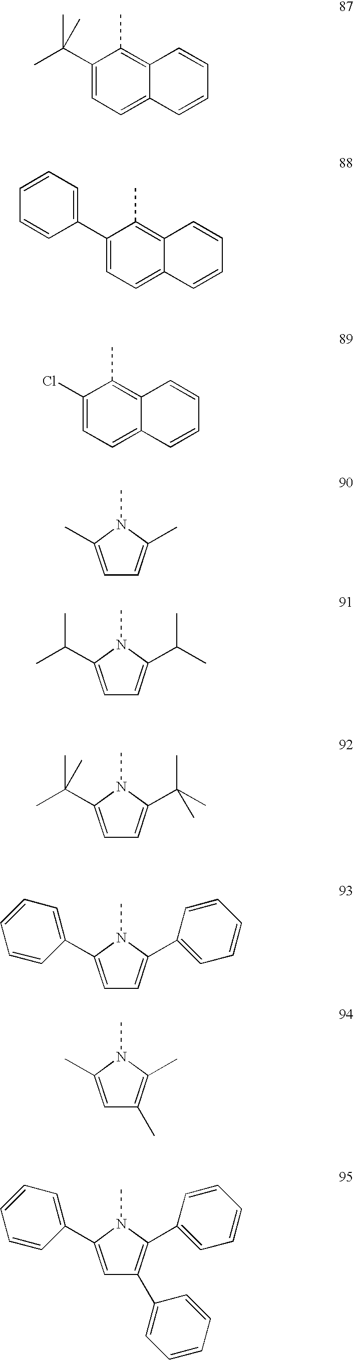

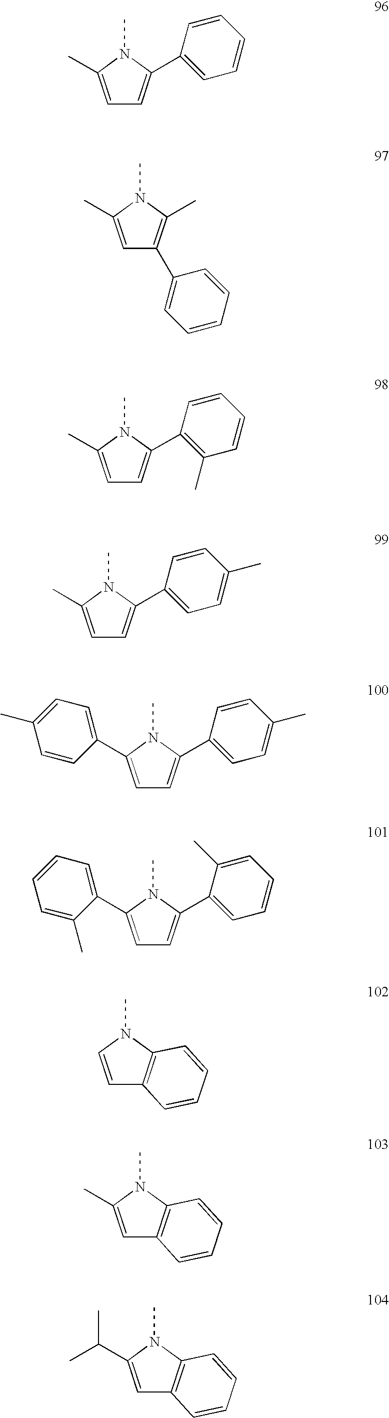

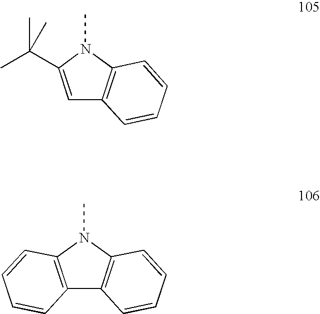

For the purposes of the present invention, ligands Q are all monoanionic, dianionic or uncharged ligands known to those skilled in the art which are bound either covalently or via a coordinate bond to M₁ and/or M₂, where the index m1 and m2 indicates that a plurality of either identical or different Q ligands from the group of Q can be bound to a metal M₁ or M₂.

The monoanionic ligands are preferably selected from the group consisting of halide, hydride, C₁₋₂₀-alkyl groups, C₁₋₂₀-alkenyl groups, C₅-C₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical, —OT¹, —OT¹T², —NT³¹⁴, —NT⁵T⁶T⁷, —PT⁸T⁹, —PT ¹⁰T¹¹T¹², where T¹ to T¹² are identical or different and are selected independently from the group consisting of H, C₁₋₂₀-alkyl groups, C₆₋₂₀-cycloalkyl groups, C₆₋₂₀-aryl groups, C₆₋₂₀-alkylaryl groups having C₁₋₂₀ groups in the alkyl radical and C₆₋₂₀ groups in the aryl radical.

For the purposes of the present invention, halides are fluorine, chlorine, bromine or iodine, preferably chlorine and bromine.

Preferred C₁₋₂₀-alkyl groups, C₁₋₂₀-alkenyl groups, C₅-C₂₀-cycloalkyl groups, C₆₋₂₀-aryl groups, C₁₋₂₀-heteroaryl groups and alkylaryl groups having C₁₋₂₀ groups in the alkyl radical and C₆₋₂₀ groups in the aryl radical are the same as those described above for the radicals R.

The dianionic ligands are preferably selected from the group consisting of 1,3-alkanediyl compounds, 1,4-alkanediyl compounds, 1,5-alkanediyl compounds, 1,ω-alkanediyl compounds, dialkoxides, dithiolates and diamides. Very particularly preferred dianionic ligands are 1,4-butanediyl, 1,5-pentanediyl, 1,2-ethanediolato, 1,2-ethanedithiolato, 1,2-ethanediamido and 1,2-bishydroxylatobenzene.

The uncharged ligands are preferably selected from the group consisting of ethers, amines, phosphines and phosphine oxides, olefins and acetylenes, carbon monoxide, nitrogen (N₂), hydrogen (H₂), carbenes and phosphorus ylides. Preferred ethers are diethyl ether, diisopropyl ether, tetrahydrofuran and 1,2-dimethoxyethane. Preferred amines are ammonia, triethylamine, pyridine, bipyridine, cyclohexylamine. Preferred phosphines and phosphine oxides are tri-tert-butylphosphine, tri-n-butylphosphine, triphenylphosphine, triphenylphosphine oxide, bis(diphenyl-phosphino)ethane. Preferred olefins and acetylenes are ethene, propene, hexene, cyclopentene, styrene, stilbene, butadiene, isoprene, phenylacetylene.

Preferred phosphorus ylides are compounds of the formula, 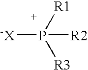
where R1, R2, R3 are selected from the group of R and X is selected from among oxygen, —N-T¹ and —CT¹T², where T¹ to T¹² are identical or different and are selected independently from the group consisting of H, C₁₋₂₀-alkyl groups, C₆₋₂₀-cycloalkyl groups, C₆₋₂₀-aryl groups, C₆₋₂₀-alkylaryl groups having C₁₋₂₀ groups in the alkyl radical and C₆₋₂₀ groups in the aryl radical.

For the present purposes, halides are fluorine, chlorine, bromine or iodine, preferably chlorine and bromine.

Preferred C₁₋₂₀-alkyl groups, C₁₋₂₀-alkenyl groups, C₅-C₂₀-cycloalkyl groups, C₆₋₂₀-aryl groups, C₁₋₂₀-heteroaryl groups and alkylaryl groups having C¹⁻²⁰ groups in the alkyl radical and C₆₋₂₀ groups in the aryl radical are the same as described above for the radicals R.

Particular preference is given to R1=R2=R3=phenyl, cyclohexyl, methyl, ethyl, isopropyl, methoxy, phenoxy or dimethylamino and X═CH₂, benzyl, cyclopropane-1,1-diyl, fulvenyl, phenylimine, trimethylsilylimine, tert-butylimine, ethane-1,1-diyl or oxo.

Among the group of monoanionic, dianionic and nonanionic ligands, the monoanionic ligands are preferred. Very particular preference is given to the halides and acetylacetonate derivatives.

For the purposes of the present invention, A1 and A2 are all bridges which are known to those skilled in the art and comprise a substituted or unsubstituted atom and/or groups which link the centres L1 to L2 or L3 to L4, where A1 and A2 can also have further coordination sites for the metal centres M₁ and M₂

Preference is given to A1 and A2 being identical or different and being selected independently from the group consisting of saturated or unsaturated hydrocarbon radicals having from 1 to 20 carbon atoms, cyclic saturated or unsaturated hydrocarbon radicals having from 4 to 20 carbon atoms, in which case L1 and L2 or L3 and L4 are bound directly to the ring, heterocyclic saturated or unsaturated compounds having from 3 to 20 carbon atoms, nitrogen-containing groups, phosphorous containing groups, silicon-containing groups, tin-containing groups, germanium-containing groups and boron-containing groups, where all these groups may bear further single-bonded substituents Z₁ to Z₁₀ and/or double-bonded substituents E₁ to E₂.

Preferred saturated or unsaturated hydrocarbon radicals having from 4 to 20 carbon atoms are the structures of the formulae 107 to 145 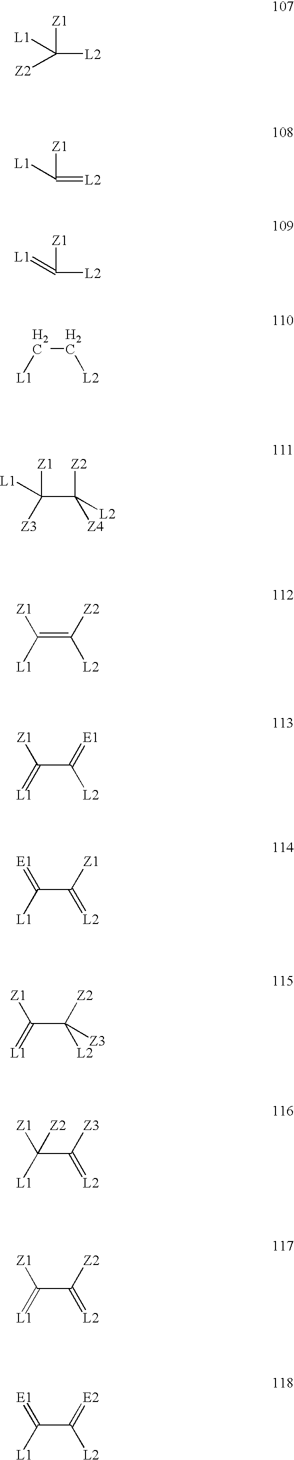 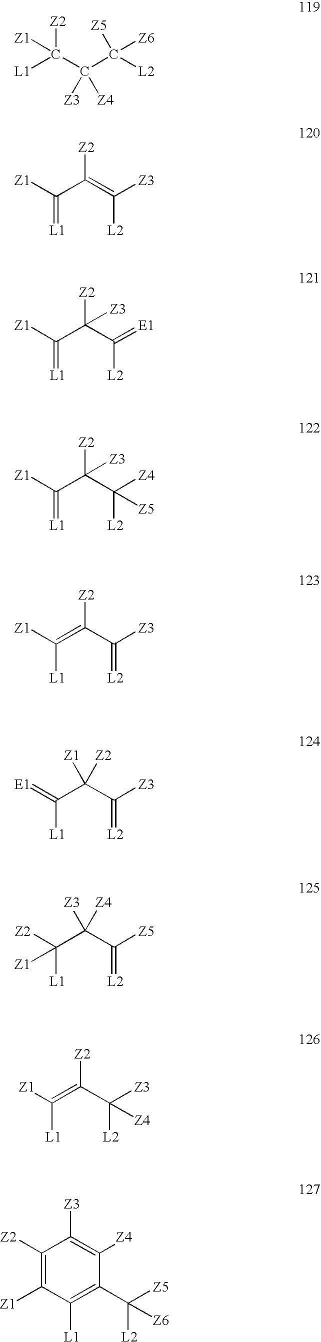 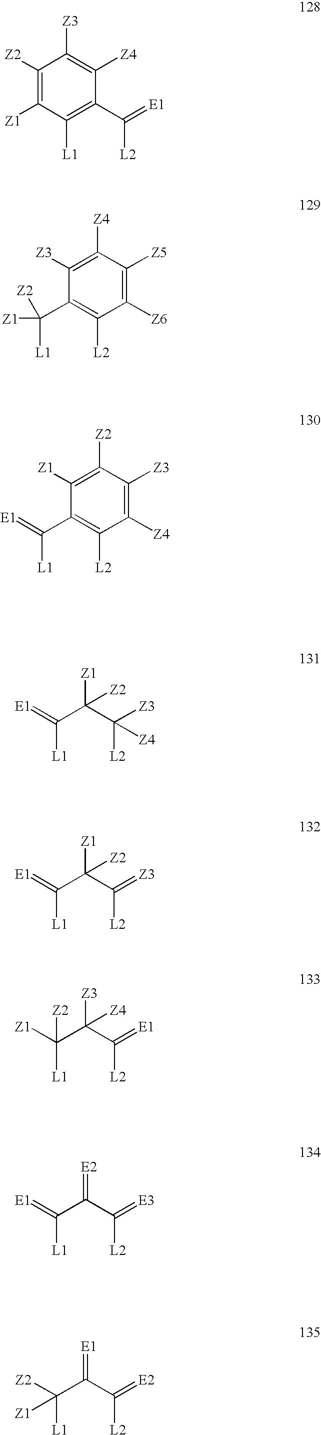 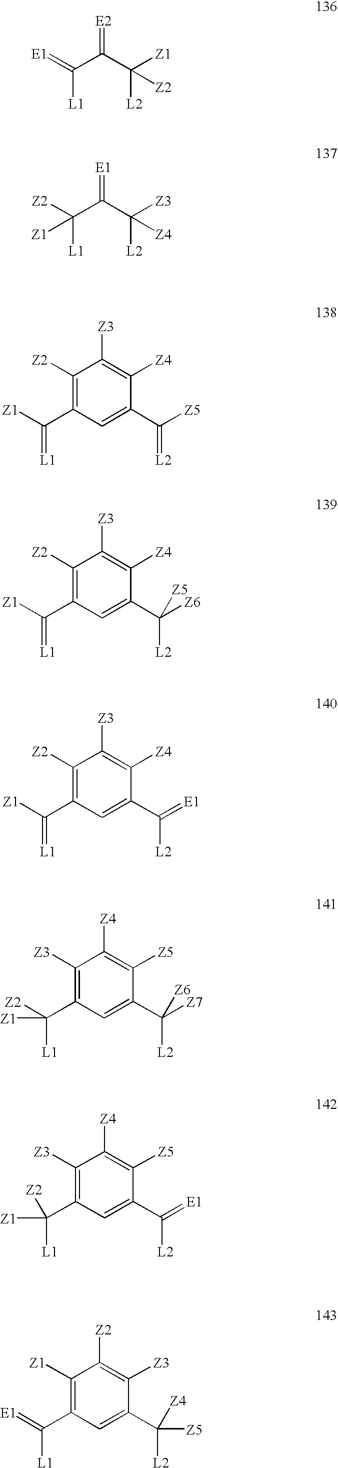 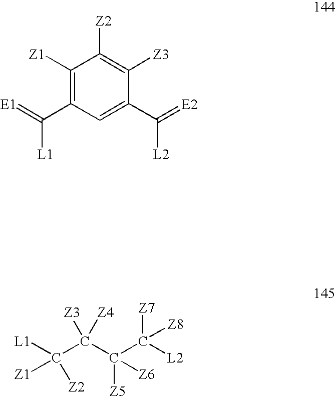
where A1 is shown as bridging element of L1 or L2; for A2, it is necessary to replace L1 and L2 by L3 and L4.

Preferred cyclic saturated or unsaturated hydrocarbon groups which have 4-20 carbon atoms and in the case of which L1 and L2 or L3 and L4 are bound directly to the ring are substituted or unsubstituted benzene, naphthalene and anthracene rings of the formulae 146 to 157 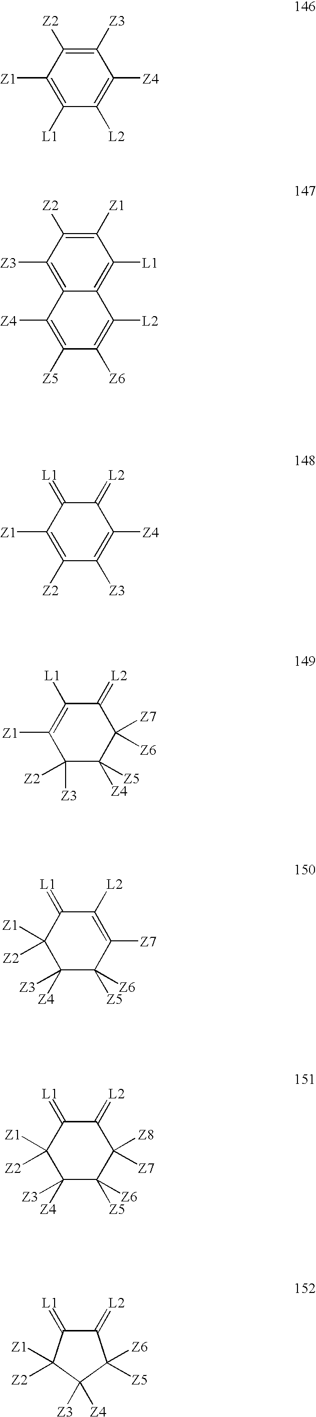 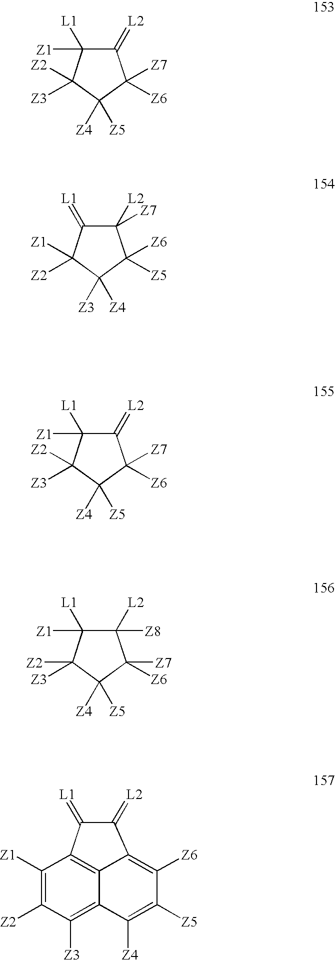
where A1 is shown as bridging element of L1 or L2; for A2, it is necessary to replace L1 and L2 by L3 and L4.

Preferred heterocyclic compounds having from 3 to 20 carbon atoms and one or more heteroatoms are substituted or unsubstituted pyridine, quinoline, thiophene and furan rings of the formulae 158 to 204 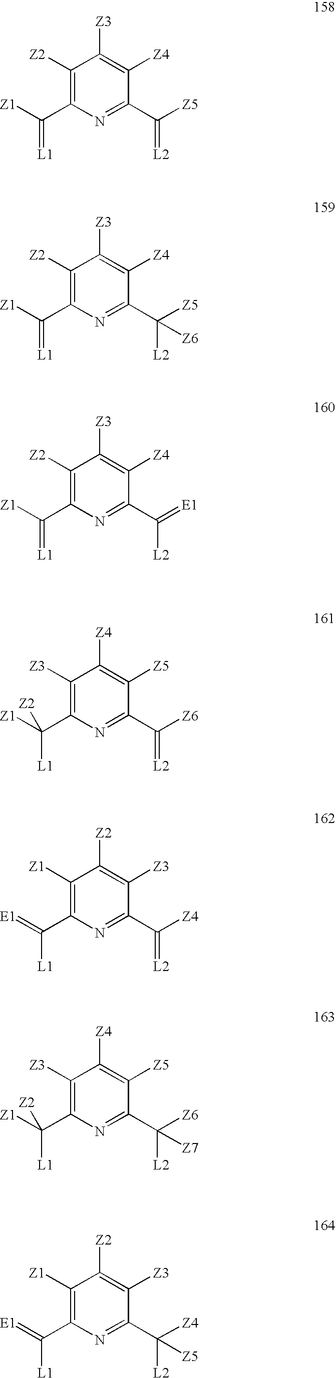 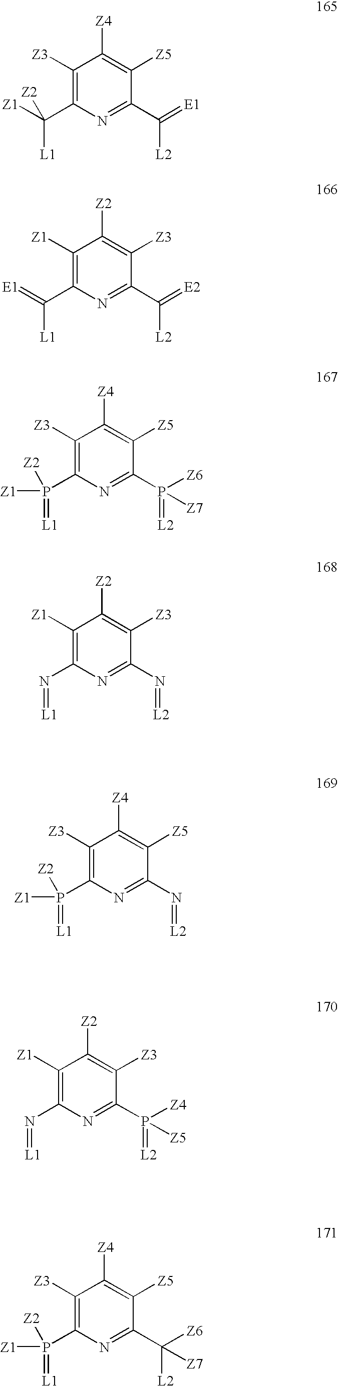 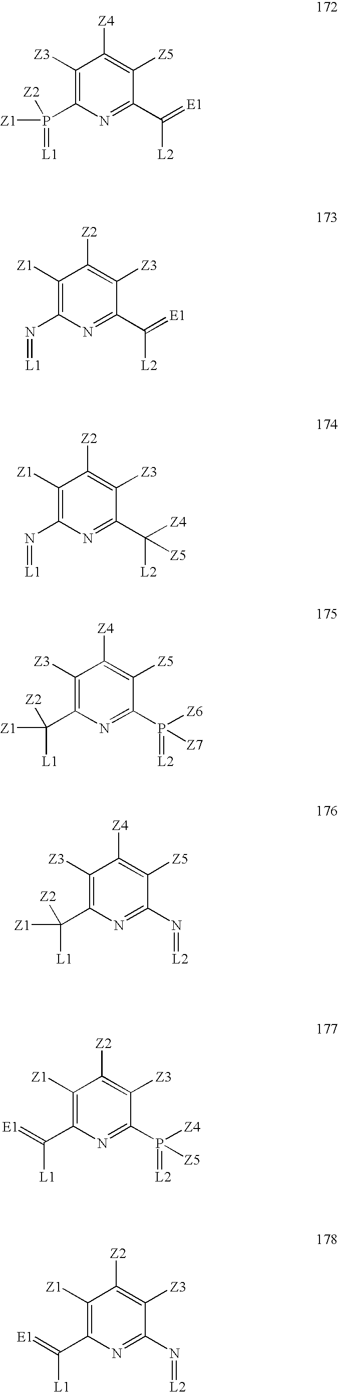 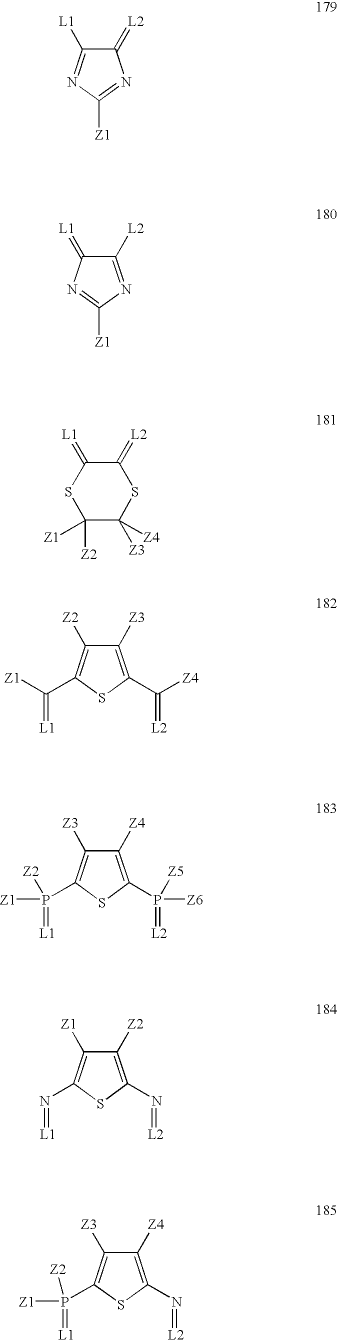 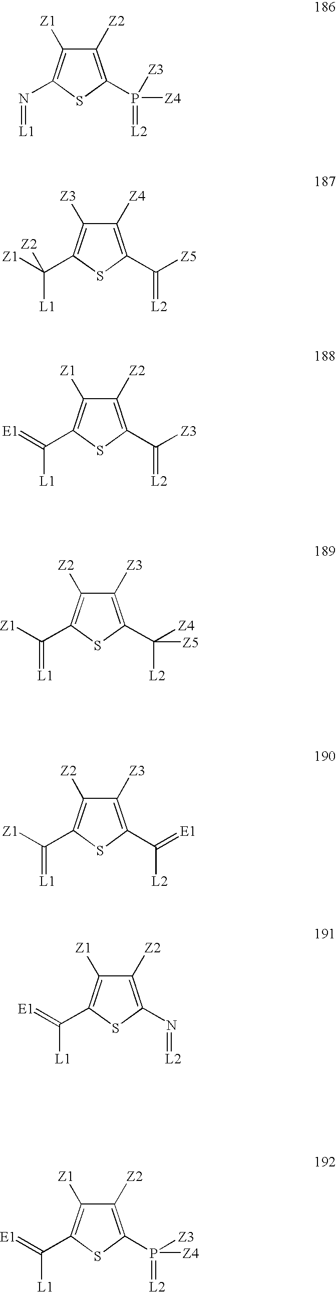 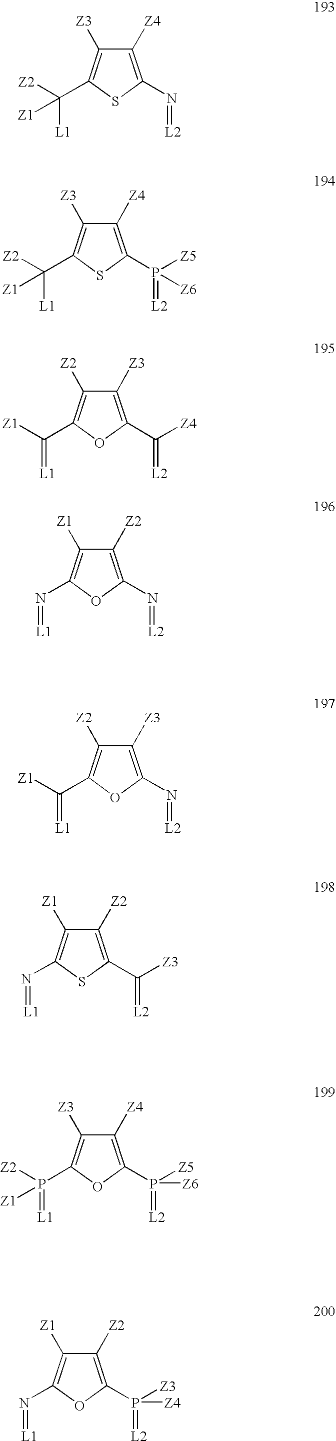 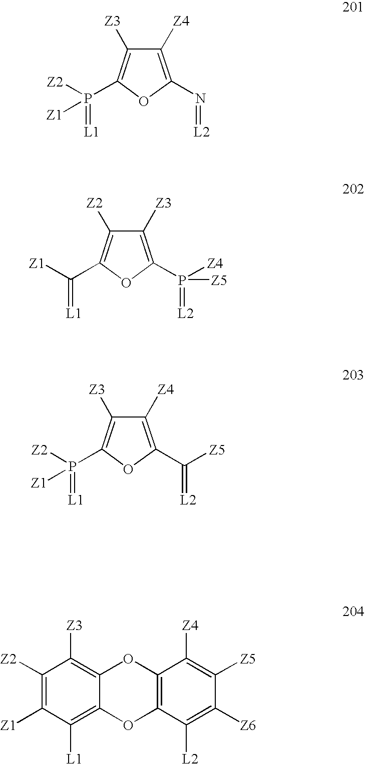
where A1 is shown as bridging element of L1 or L2; for A2, it is necessary to replace L1 and L2 by L3 and L4.

Preferred nitrogen-containing groups are those of the following formulae 205 to 221 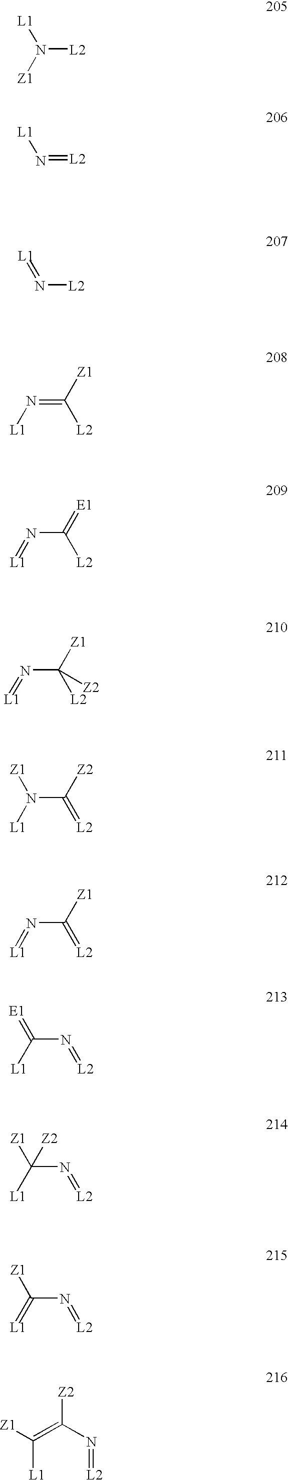 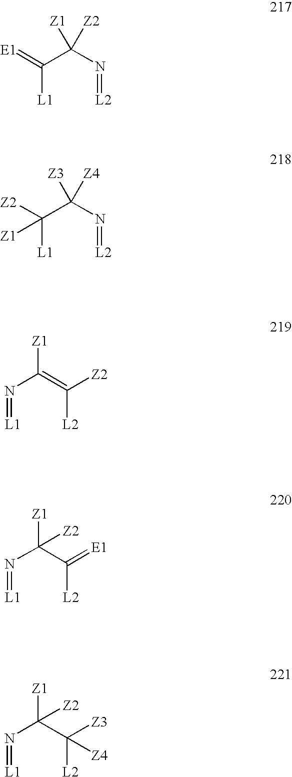
where A1 is shown as bridging element of L1 or L2; for A2, it is necessary to replace L1 and L2 by L3 and L4.

Preferred phosphorus-containing groups are those of the following formulae 222 to 233 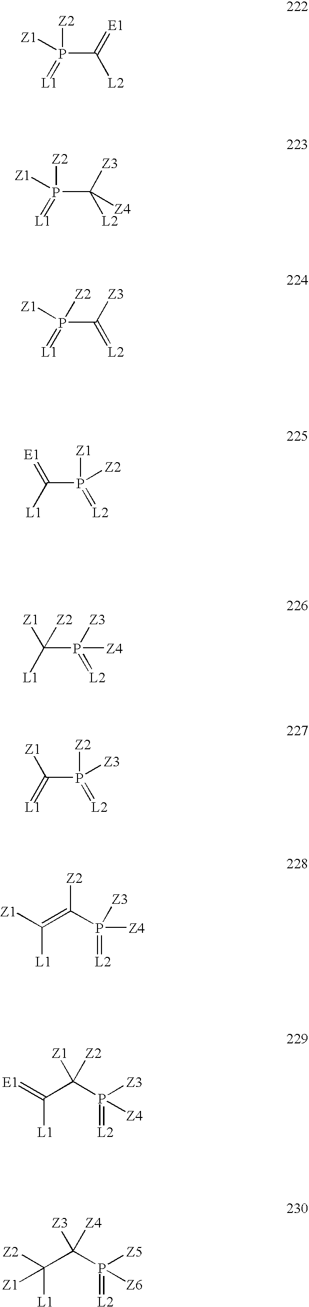 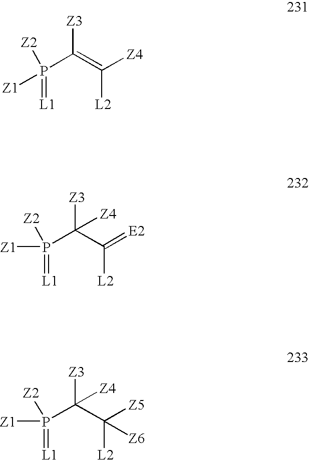
where A1 is shown as bridging element of L1 or L2; for A2, it is necessary to replace L1 and L2 by L3 and L4.

Preferred groups which connect L1 to L2 and/or L3 to L4 via one or more silicon centres are those of the formulae 234 to 236 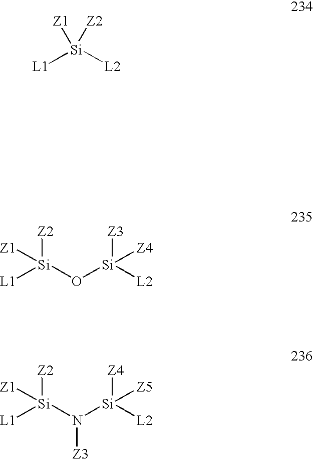
where A1 is shown as bridging element of L1 or L2; for A2, it is necessary to replace L1 and L2 by L3 and L4.

Preferred groups which connect L1 to L2 and/or L3 to L4 via one or more tin centres are those of the following formulae 237 and 238 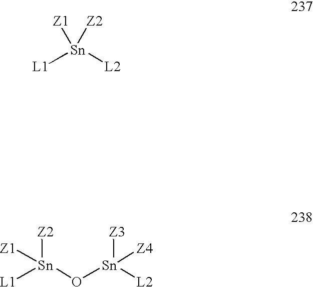
where A1 is shown as bridging element of L1 or L2; for A2, it is necessary to replace L1 and L2 by L3 and L4.

A preferred group which connects L1 to L2 and/or L3 to L4 via a germanium centre is that of the formula 239 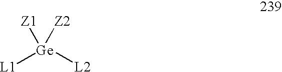
where A1 is shown as bridging element of L1 or L2; for A2, it is necessary to replace L1 and L2 by L3 and L4.

Preferred groups which connect L1 to L2 and/or L3 to L4 via a boron centre are —BH—, —B(CH₃)—, —BPh—, —BF—, —BCl—.

Preferred groups which connect L1 to L2 and/or L3 to L4 via phosphorus centres are —P(Ph)—P(Ph)—, —P(Me)—P(Me)—.

E₁ and E₂ are double-bonded groups and can be identical or different and are selected independently from the group consisting of S, O, CZ₁Z₂, NZ₁, OZ₁⁺, NZ₁Z₂^{+.}

Z₁ to Z₁₀ can be identical or different and are selected independently from the group consisting of halides, hydride, C₁₋₂₀-alkyl groups, C₁₋₂₀-alkenyl groups, C₅₋₂₀-cycloalkyl groups, C₆₋₂₀-aryl groups, alkylaryl groups having C₁₋₂₀ groups in the alkyl radical and C₆₋₂₀ groups in the aryl radical, —OT¹, OT¹T², —NT³T, NT⁵T⁶T⁷, —PT⁸T⁹, —PT¹⁰T¹¹T¹² where T¹ to T¹² can be identical or different and are selected independently from the group consisting of H, C₁₋₂₀-alkyl groups, C₅₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical and arylalkyl groups having C₁₋₂₀ groups in the alkyl radical and C₆₋₂₀ groups in the aryl radical. The preferred halides, C₁₋₂₀-alkyl groups, C₁₋₂₀-alkenyl groups, C₅₋₂₀-cycloalkyl groups, C₆₋₂₀-aryl groups, alkylaryl groups having C₁₋₂₀ groups in the alkyl radical and C₆₋₂₀ groups in the aryl radical, —OT¹, OT¹T², —NT³T⁴, NT⁵T⁶T⁷, —PT⁸T⁹, —PT¹⁰T¹¹T¹² are the same as those described for the radicals R.

For the purposes of the present invention, B is any group known to those skilled in the art which can electronically link the centres L2 and L3 to one another. For the present purposes, an electronic linkage between the centres L2 and L3 is a group which, as a result of delocalization of its π electrons, can shift the charges both into the rings comprising L1; A1; L2 and M₁ and the substituents of this ring and into the ring comprising L3; A2; L4 and M₂ and substituents of this ring.

B is preferably an aromatic or heteroaromatic group which may in turn bear substituents G₁ to G₈.

B is particularly preferable an aromatic or heteroaromatic group whose points of linkage to L2 and L3 are not in the ortho position relative to one another.

Very particular preference is given to the groups of the formulae 240 to 249

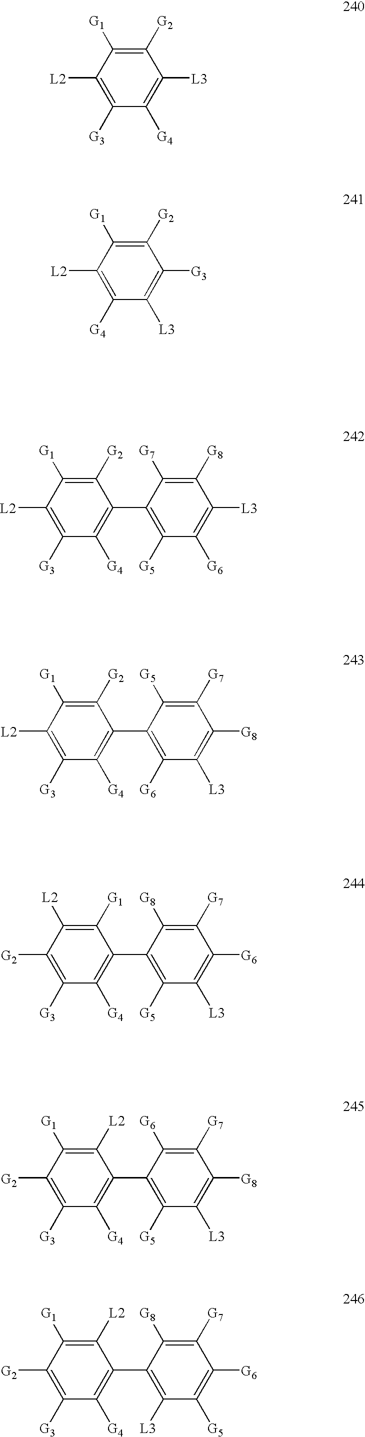

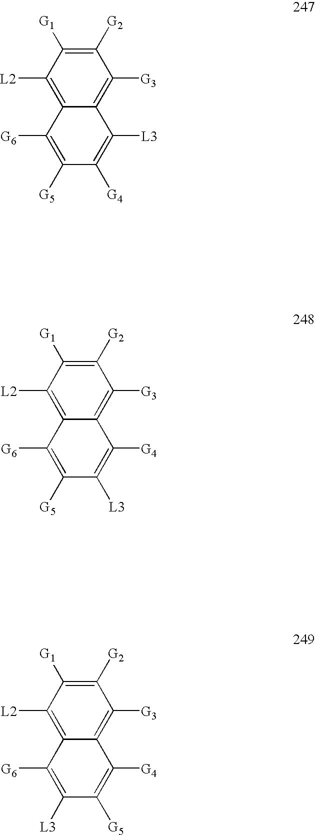

Here, the substituents G₁ to G₈ are identical or different and are selected independently from the group consisting of halide, hydride, C₁₋₂₀-alkyl groups, C₁₋₂₀-alkenyl groups, C₅₋₂₀-cycloalkyl groups, C₆₋₂₀-aryl groups, alkylaryl groups having C₁₋₂₀ groups in the alkyl radical and C₆₋₂₀ groups in the aryl radical, —OT¹, OT¹T², —NT³T⁴, NT⁵T⁶T⁷, —PT³T⁹, —PT¹⁰T¹¹T¹², where T¹ to T¹² are identical or different and are selected independently from the group consisting of H, C₁₋₂₀-alkyl groups, C₅₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical and arylalkyl groups having C¹-20 groups in the alkyl radical and C₆₋₂₀ groups in the aryl radical.

Preferred basic structures having N—O ligands for L1 and L2 and/or L3 and L4 are those of the following formulae 250 to 263

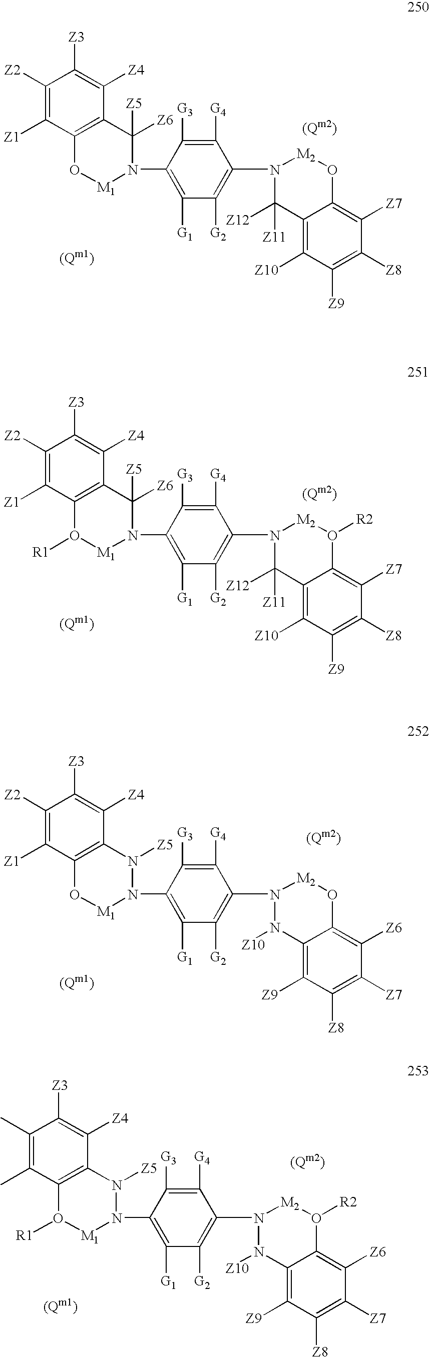

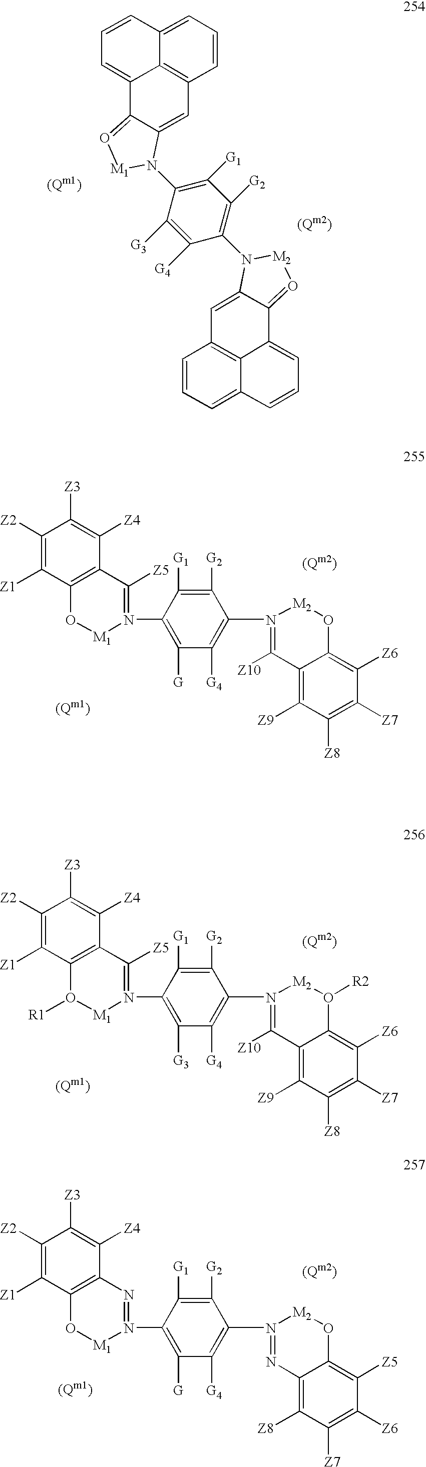

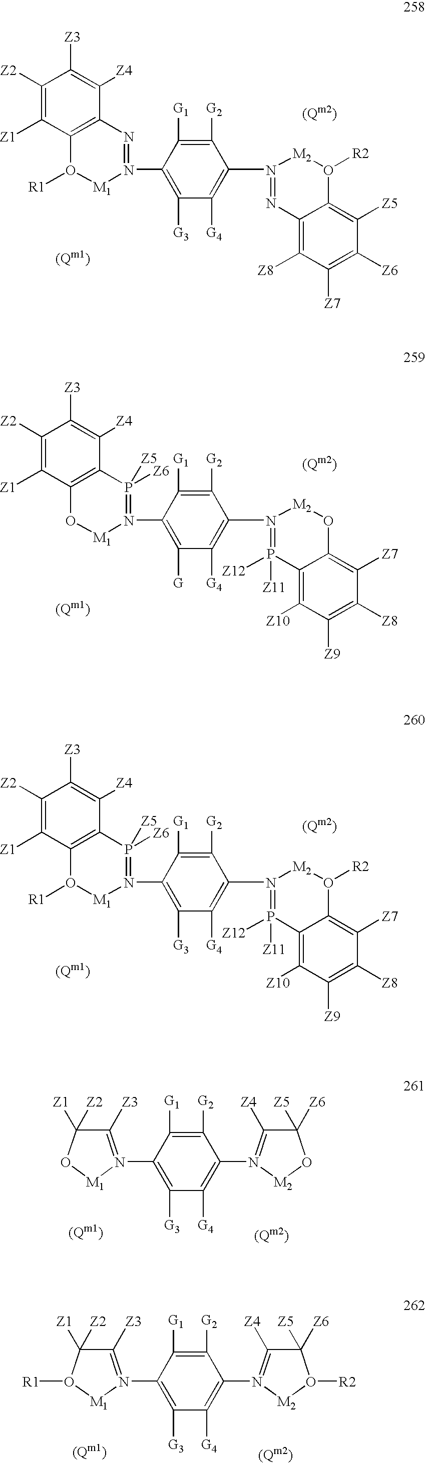

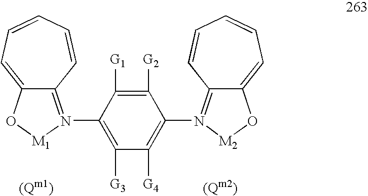

Particularly preferred basic structures for compounds having N—O ligands for L1 and L2 and/or L3 and L4 are those of the following formulae 255 to 258, 264, 265, 261 to 263

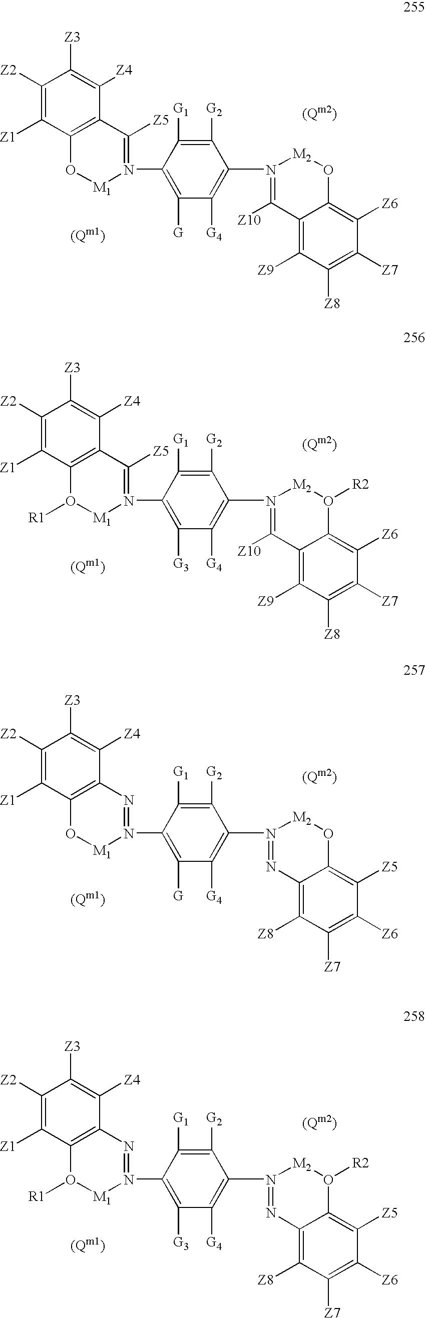

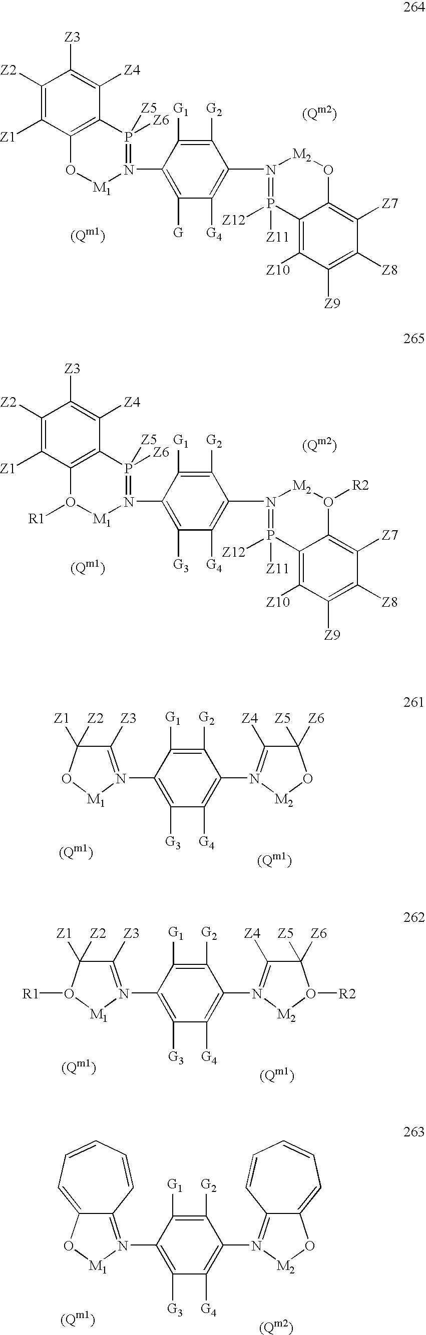

Preferred structures having N—N ligands for L1 and L2 and/or L3 and L4 are those of the following formulae 266 to 282

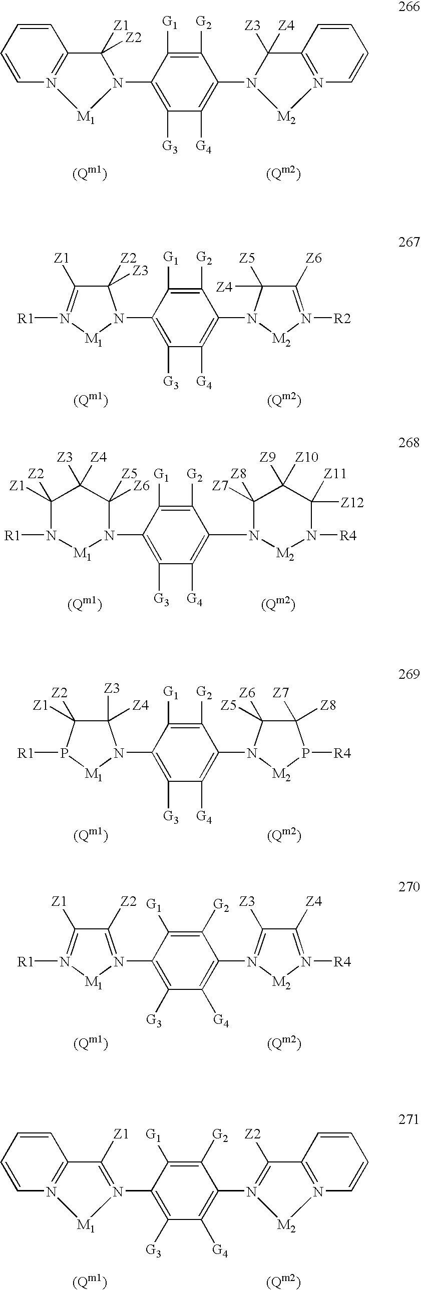

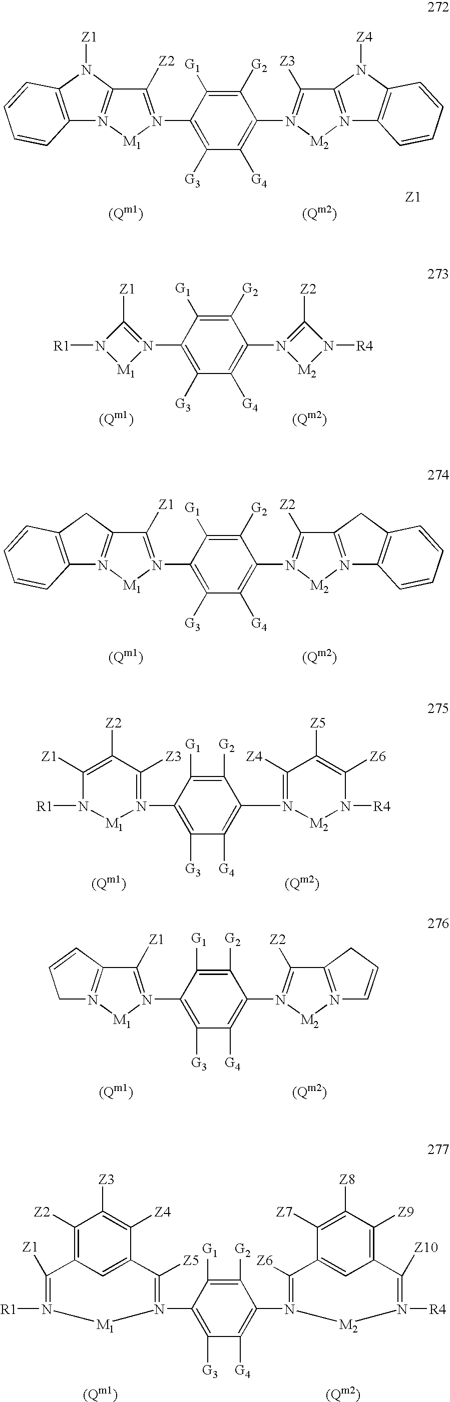

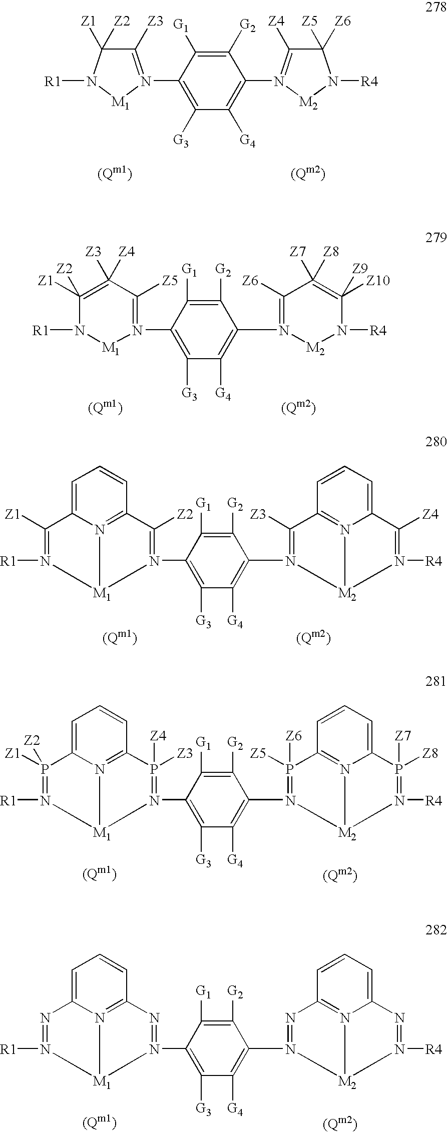

Particularly preferred basic structures for N—N ligands having a heteroatom in the building blocks A1 and A2 are:

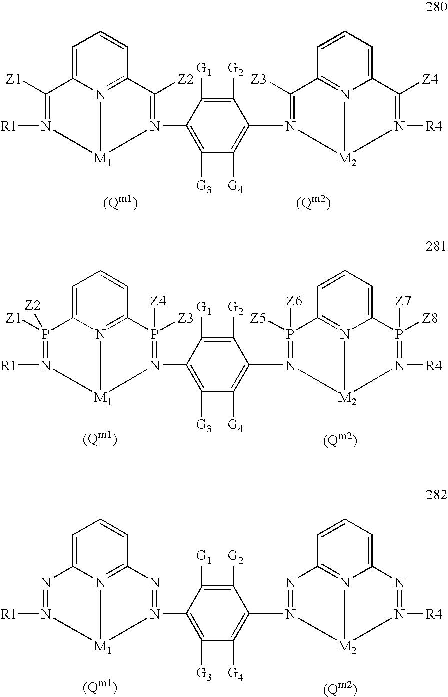

A particularly preferred structure having a P—N ligand for L1 and L2 and/or L3 and L4 is:

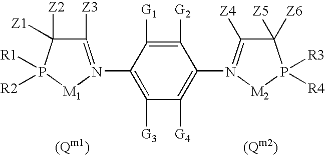

Particularly preferred basic structures having S—N ligands for L1 and L2 and/or L3 and L4 are those of the following formulae 284 and 285

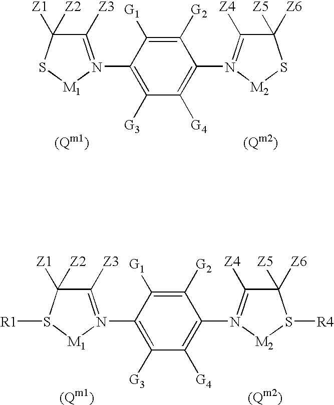

A special preference is given to the following basic structure:

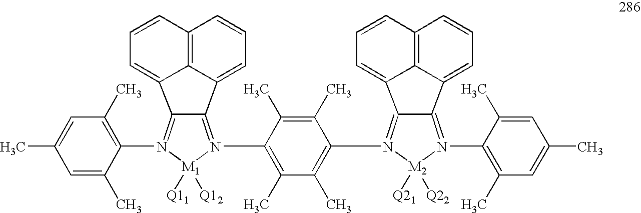

The compounds of the invention can be prepared by various methods.

Thus, one process for comparing compounds of the type (I) can comprise the following steps:
a) provision of a compound of the formula (K-1), 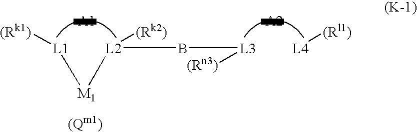
   where m1 is as defined above, n3 is greater than or equal to k3 and l4 is greater than or equal to k4;
b) reaction of a compound of the formula (K-1) with a metal compound of the formula M₂(Q^{o2}), where o2 can assume values in the range from 1 to 8.

A further process for preparing the novel compounds of the formula (I) comprises the steps:
a) provision of a compound of the formula (K-1), 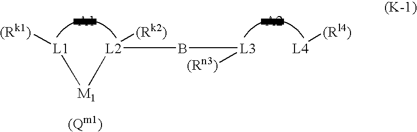
   where m1 is as defined above, n3 is greater than or equal to k3 and l4 is greater than or equal to k4;
b) reaction of a compound of the formula (K-1) with a metal compound of the formula M₃(Q^{o3}), where o3 can assume values in the range from 1 to 8, to form a compound of the formula (K-2), 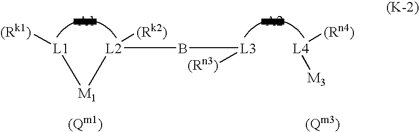
   where n4 is smaller than l4, and subsequent
c) reaction of a compound of the formula (K-2) with a metal compound of the formula M₂(Q^{o2}), where o2 can assume values in the range from 1 to 8.

A further process for preparing novel compounds of the formula (1) comprises the steps:
a) provision of a compound of the formula (K-1), 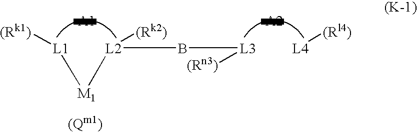
   where m1 is as defined above, n3 is greater than or equal to k3 and l4 is greater than or equal to k4;
b) reaction of a compound of the formula (K-1) with a metal compound of the formula M₃(Q^{o3}), where o3 can assume values in the range from 1 to 8, to form a compound of the formula (K-3), 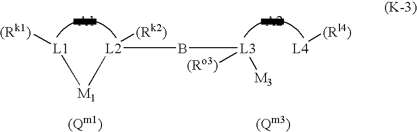
   where o3 is smaller than n3, and subsequent
c) reaction of a compound of the formula (K-3) with a metal compound of the formula M₂(Q^{o2}), where o2 can assume values in the range from 1 to 8.

A further process for preparing novel compounds of the formula (I) comprises the steps:
a) provision of a compound of the formula (K-1), 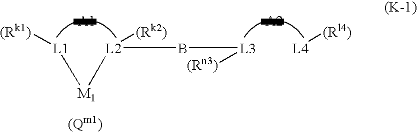
   where m1 is as defined above, n3 is greater than or equal to k3 and l4 is greater than or equal to k4,
b) reaction of a compound of the formula (K-1) with a metal compound of the formula M₃(Q^{o3}), where o3 can assume values in the range from 1 to 8, to form a compound of the formula (K-4), 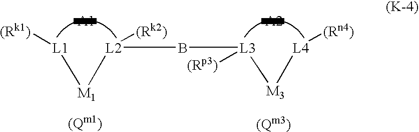
   where p3 is smaller than n3 and n4 is smaller than l4, or else p3 is smaller than n3 and n4 is equal to l4, or else n4 is smaller than l4 and p3 is equal to n3, and subsequent
c) reaction of a compound of the formula (K-4) with a metal compound of the formula M₂(Q^{o2}), where o2 can assume values in the range from 1 to 8.

A further process for preparing novel compounds of the formula (I) comprises the steps:
a) provision of a compound of the formula (K-1), 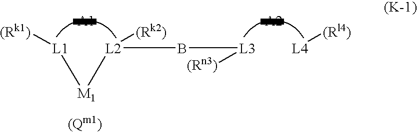
   where m1 is as defined above, n3 is greater than or equal to k3 and l4 is greater than or equal to k4,
b) reaction of a compound of the formula (K-1) with a metal compound of the formula M₃(Q^{o3}), where o3 can assume values in the range from 1 to 8, to form a compound of the formula (K-5a), 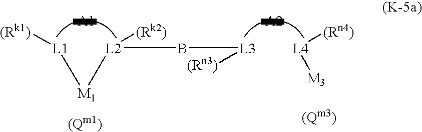
   where n4 is smaller than or equal to l4, and subsequent
c) reaction of a compound of the formula (K-5a) with a metal compound of the formula M₄(Q^{o4}), where o4 can assume values in the range from 1 to 8, to form a compound of the formula (K-5b), 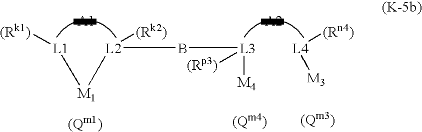
   where p3 is smaller than or equal to n3, and subsequent
d) reaction of a compound of the formula (K-5b) with a metal compound of the formula M₂(Q^{o2}), where o2 can assume values in the range from 1 to 8.

A further process for preparing novel compounds of the formula (I) comprises the steps:
a) provision of a compound of the formula (K-1), 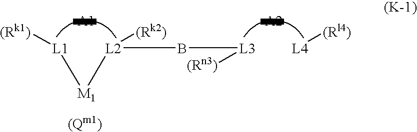
   where m1 is as defined above, n3 is greater than or equal to k3 and l4 is greater than or equal to k4;
b) reaction of a compound of the formula (K-1) with a metal compound of the formula M₃(Q^{o3}), where o3 can assume values in the range from 1 to 8, to form a compound of the formula (K-6a), 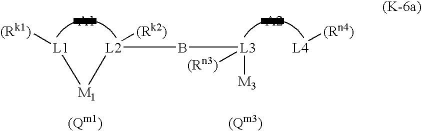
   where n4 is smaller than or equal to l4;
c) reaction of a compound of the formula (K-6a) with a metal compound of the formula M₄(Q^{o4}), where o4 can assume values in the range from 1 to 8, to form a compound of the 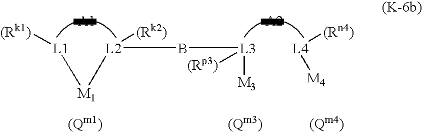
   where p3 is smaller than or equal to n3, and subsequent
d) reaction of a compound of the formula (K-6b) with a metal compound of the formula M₂(Q^{o2}), where o2 can assume values in the range from 1 to 8.

There are also a number of possibilities for preparing the compound of the formula (K-1).

One process for preparing compounds of the formula (K-1) comprises the steps:
a) provision of a compound of the formula (VII), 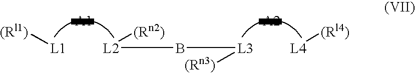
   where l1 is greater than or equal to k1, n2 is greater than or equal to k2, n3 is greater than or equal to k3 and l4 is greater than or equal to k4;
b) reaction of a compound of the formula (VII) with a metal compound of the formula M₁(Q^{m1}), where m1 is as defined above.

A further process for preparing compounds of the formula (K-1) comprises the steps:
a) provision of a compound of the formula (VII), 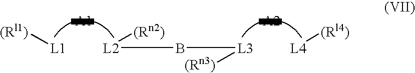
   where l1 is greater than or equal to k1, n2 is greater than or equal to k2, n3 is greater than or equal to k3 and l4 is greater than or equal to k4;
b) reaction of a compound of the formula (VI) with a metal compound of the formula M₃(Q^{o3}), where o3 can assume values in the range from 1 to 8, to form a compound of the formula (K-8), 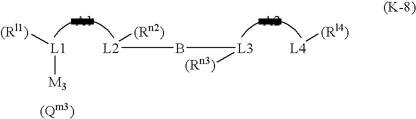
   where n1 is smaller than or equal to l1, and subsequent
c) reaction of a compound of the formula (K-8) with a metal compound of the formula M₁(Q^{m1}), where m1 is as defined above.

A further process for preparing compounds of the formula (K-1) comprises the steps:
c) provision of a compound of the formula (VII), 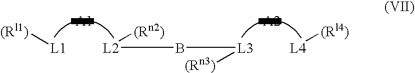
   where l1 is greater than or equal to k1, n2 is greater than or equal to k2, n3 is greater than or equal to k3 and l4 is greater than or equal to k4,
d) reaction of a compound of the formula (VII) with a metal compound of the formula M₃(Q^{o3}), where o3 can assume values in the range from 1 to 8, to form a compound of the formula (K-9), 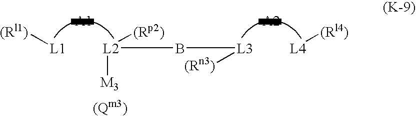
   where p2 is smaller than or equal to n2, and subsequent
c) reaction of a compound of the formula (K-9) with a metal compound of the formula M₁(Q^{m1}), where m1 is as defined above.

A further process for preparing compounds of the type (K-1) comprises the steps:
a) provision of a compound of the formula (VII), 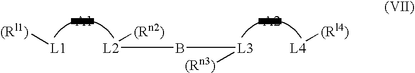
   where l1 is greater than or equal to k1, n2 is greater than or equal to k2, n3 is greater than or equal to k3 and l4 is greater than or equal to k4,
b) reaction of a compound of the formula (VII) with a metal compound of the formula M₃(Q^{o3}), where o3 can assume values in the range from 1 to 8, to form a compound of the 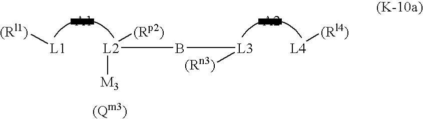
   where p2 is smaller than or equal to n2,
c) reaction of a compound of the formula (K-10a) with a metal compound of the formula M₄(Q^{o4}), where o4 can assume values in the range from 1 to 8, to form a compound of the formula (K-10b), 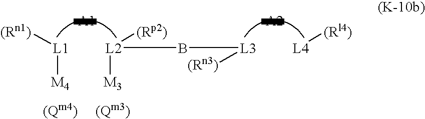
   where n1 is smaller than or equal to l1, and subsequent
d) reaction of a compound of the formula (K-10b) with a metal compound of the type M₁(Q^{m1}), where m1 is as defined above.

A further process for preparing compounds of the formula (K-1) comprises the steps:
a) provision of a compound of the formula (VI), 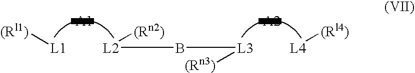
   where l1 is greater than or equal to k1, n2 is greater than or equal to k2, n3 is greater than or equal to k3 and l4 is greater than or equal to k4;
b) reaction of a compound of the formula (VII) with a metal compound of the formula M₃(Q^{o3}), where o3 can assume values in the range from 1 to 8, to form a compound of the formula (K-1 a), 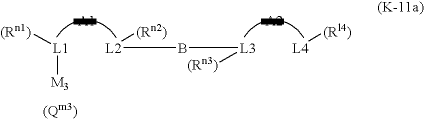
   where n1 is smaller than or equal to l1;
c) reaction of a compound of the formula (K-11 a) with a metal compound of the formula M₄(Q^{o4}), where o4 can assume values in the range from 1 to 8, to form a compound of the formula (K-11b), 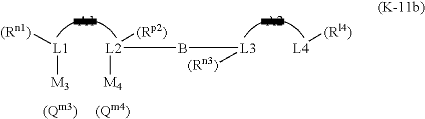
   where p2 is smaller than or equal to n2, and subsequent
d) reaction of a compound of the formula (K-11b) with a metal compound of the formula M₁(Q^{m1}), where m1 is as defined above.

A further process for preparing compounds of the type (K-1) comprises the steps:
a) provision of a compound of the formula (VII), 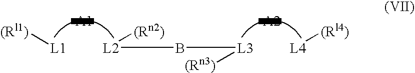
   where l1 is greater than or equal to k1, n2 is greater than or equal to k2, n3 is greater than or equal to k3 and l4 is greater than or equal to k4,
b) reaction of a compound of the formula (VII) with a metal compound of the formula M₃(Q^{o3}), where o3 can assume values in the range from 1 to 8, to form a compound of the formula (K-12), 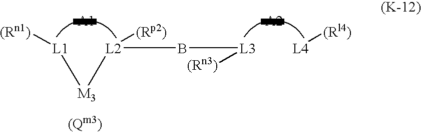
   where p2 is smaller than n2 and n1 is smaller than 11, or else p2 is smaller than n2 and n1 is equal to l1, or else n1 is smaller than 11 and p2 is equal to n2, and subsequent
c) reaction of a compound of the formula (K-12) with a metal compound of the formula M₁(Q^{m1}), where m1 is as defined above.

There are also a number of possibilities for preparing the compound of the formula (VII). One process for preparing compounds of the formula (VII) comprises the steps:
a) provision of a compound of the functionalized building block of the formula (S1-1), 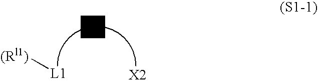
   where X2 is a reactive group and the index l1 indicates the number and the differences of the individual substituents of the group R and can have a value from 0 to α−1, where α corresponds to the valency of L1,
b) provision of a compound of the functionalized building block of the formula (S1-2), 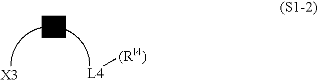
   where X3 is a reactive group and the index l4 indicates the number and the differences of the individual substituents from the group of R and can have any value from 0 to δ−1, where δ corresponds to the valency of L4,
c) reaction of a compound of the building block of the formula (S1-1) with a compound of the bifunctional agent of the formula (S1-3), 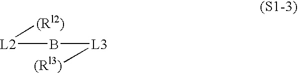
   where the index l2 corresponds to the number present and the difference of the individual substituents from the group of R and can have any value from 0 to β−1, where P corresponds to the valency of L2, and the index l3 corresponds to the number present and the difference of the individual substituents from the group of R and can have any value from 0 to γ−1, where γ corresponds to the valency of L3, to form a compound of the formula (S1-4), 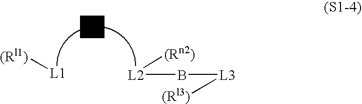
   where n2 is smaller than or equal to l2, and subsequent
d) reaction of a compound of the formula (S1-4) with a compound of the building block of the formula (S1-2) to form a compound of the formula (S1-5), 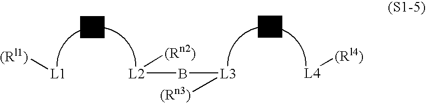
   where n3 is smaller than or equal to l3.

A further process for preparing compounds of the formula (VII) comprises the steps:
a) provision of a compound of a functionalized building block of the formula (S2-1), 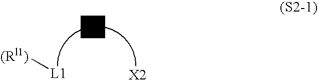
   where X2 is a reactive group and the index l1 indicates the number and the differences of the individual substituents of the group R and can have any value from 0 to α−1, where α corresponds to the valency of L1,
b) provision of a compound of a functionalized building block of the formula (S2-2), 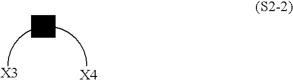
   where X3 and X4 are reactive groups,
c) reaction of a compound of the functionalized building block of the formula (S2-1) with a compound of a bifunctional agent of the formula (S2-3), 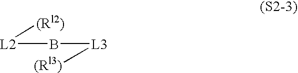
   where the index l2 corresponds to the number present and the difference of the individual substituents of the group R and can have any value from 0 to β−1, where β corresponds to the valency of L2, and the index l3 corresponds to the number present and the difference of the individual substituents of the group R and can have any value from 0 to γ−1, where y corresponds to the valency of L3, to form a compound of the formula (S24), 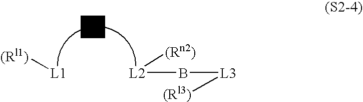
   where n2 is smaller than or equal to l2;
d) reaction of a compound of the formula (S2-4) with a compound of a functionalized building block of the formula (S2-2) to a form a compound of the formula (S2-5), 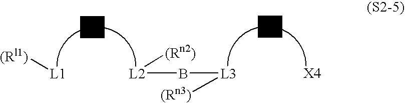
   where n3 is smaller than or equal to l3, and subsequent
e) reaction of a compound of the formula (S2-5) with an agent which allows the introduction of L4.

A further process for preparing compounds of the formula (VII) comprises the steps:
a) provision of a compound of a functionalized building block of the formula (S3-1), 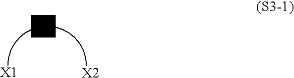
   where X1 and X2 are reactive groups,
b) provision of a compound of a functionalized building block of the formula (S3-2), 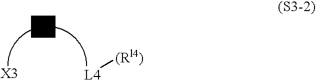
   where X3 is a reactive group and the index l4 indicates the number and the differences of the substituents of the group R and can have any value from 0 to δ−1, where δ corresponds to the valency of L4,
c) reaction of a compound of a functionalized building block of the formula (S3-1) with a compound of a bifunctional agent of the formula (S3-3), 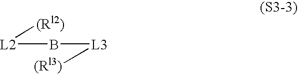
   where the index l2 corresponds to the number present and the difference of the substituents of the group of R and can have any value from 0 to β−1, where β corresponds to the valency of L2, and the index l3 corresponds to the number and the difference of the substituents of the group of R and can have any value from 0 to γ−1, where γ corresponds to the valency of L3, to form a compound of the formula (S3-4), 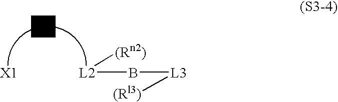
   where n2 is smaller than or equal to l2;
d) reaction of a compound of the formula (S3-4) with an agent which allows the introduction of L1 to form a compound of the formula (S3-5) 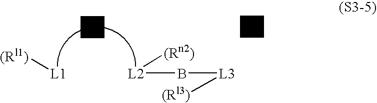
   and subsequent
e) reaction of a compound of the formula (S3-5) with a compound of a bifunctional building block of the formula (S3-2).

A further process for preparing compounds of the formula (VII) comprises the steps:
a) provision of a compound of a functionalized building block of the formula (S4-1), 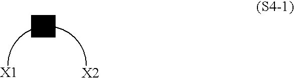
   where X1 and X2 are reactive groups,
b) provision of a compound of a bifunctional building block of the formula (S4-2), 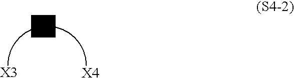
   where X3 and X4 are reactive groups,
c) provision of a compound of a functionalized building block of the formula (S4-1) with a compound of a bifunctional agent of the formula (S4-3), 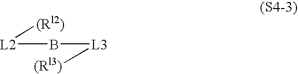
   where the index l2 corresponds to the number present and the difference of the substituents of the group of R and can have any value from 0 to β−1, where β corresponds to the valency of L2, and the index l3 corresponds to the number present and the difference of the substituents of the group R and can have any value from 0 to γ−1, where γ corresponds to the valency of L3, to form a compound of the formula (S44), 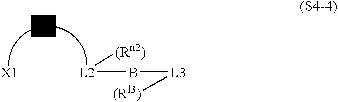
   where n2 is smaller than or equal to l2,
e) reaction of a compound of the formula (S44) with a compound of a functionalized building block of the formula (S4-2) to give a compound of the formula (S4-5), 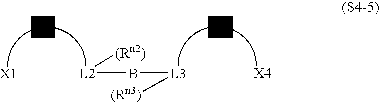
   subsequent
f) reaction of a compound of the formula (S4-5) with an agent which allows the introduction of L1 to form a compound of the formula (S4-6) 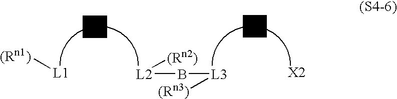
   and subsequent
g) reaction of a compound of the formula (S4-6) with an agent which allows the introduction of L4.

A further process for preparing compounds of the formula (VII) comprises the steps:
a) provision of a compound of a functionalized building block of the formula (S5-1), 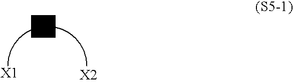
b) provision of a compound of a bifunctional building block of the formula (S5-2), 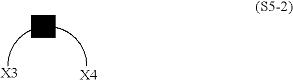
   where X3 and X4 are reactive groups,
c) reaction of a compound of a functionalized building block of the formula (S5-1) with a compound of a bifunctional agent of the formula (S5-3), 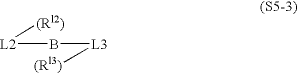
   where the index l2 corresponds to the number present and the difference of the substituents of the group R and can have any value from 0 to β−1, where β corresponds to the valency of L2, and the index l3 corresponds to the number present and the difference of the substituents of the group R and can have any value from 0 to γ−1, where γ corresponds to the valency of L3, to a form a compound of the formula (S54), 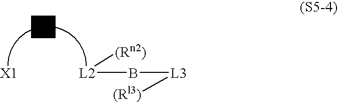
   where n2 is smaller than or equal to l2, then
d) reaction of a compound of the formula (S5-4) with an agent which allows the introduction of L1 to form a compound of the formula (S5-5), 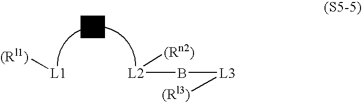
e) subsequent reaction of a compound of the formula (S5-5) with a compound of a functionalized building block of the formula (S5-2) to form a compound of the formula (S5-6) 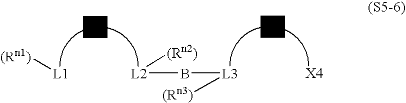
   and subsequent
f) reaction of a compound of the formula (S4-6) with an agent which allows the introduction of L4.

A further process for preparing compounds of the formula (VII) comprises the steps:
a) provision of a compound of the formula (S6-1), 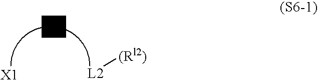
   where l12 corresponds to the number and the difference of the substituents of the group of R and can have any value from 0 to β−1, where β corresponds to the valency of L2, and X1 is a reactive group;
b) provision of a compound of a functionalized building block of the formula (S6-2), 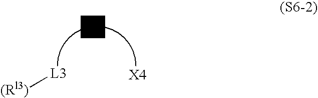
   where l3 corresponds to the number and the difference of the substituents of the group of R and can have any value from 0 to γ−1, where γ corresponds to the valency of L3, and X4 is a reactive group,
c) reaction of a compound of the formula (S6-1) with a compound of a bifunctional agent of the formula (S6-3),
   Y1—B—Y2 (S6-3)
   where Y1 and Y2 are each a reactive group, to give a compound of the formula (S64) 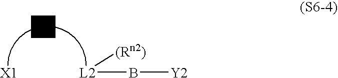
d) then reaction of a compound of the formula (S64) with a compound of a functionalized building block of the formula (S6-2) to give a compound of the formula (S6-5) 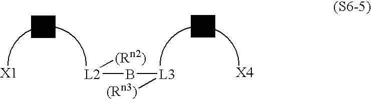
e) subsequent reaction of the compound of the formula (S6-5) with an agent which allows the introduction of L1 to form a compound of the formula (S6-6) 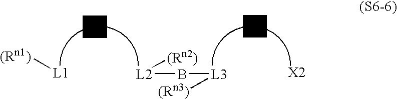
   and subsequent
f) reaction of the compound of the formula (S6-6) with an agent which allows the introduction of L4.

A further process for preparing compounds of the formula (VII) comprises the steps:
a) provision of a compound of a building block of the formula (S7-1), 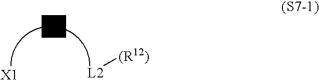
   where l2 corresponds to the number and the difference of the substituents of the group R and can have any value from 0 to β−1, where β corresponds to the valency of L2, and X1 is a reactive group,
b) provision of a compound of a functionalized building block of the formula (S7-2), 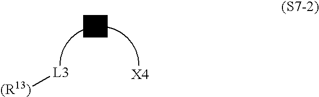
   where l3 corresponds to the number and the difference of the substituents of the group R and can have any value from 0 to γ−1, where γ corresponds to the valency of L3, and X4 is a reactive group,
c) reaction of a compound of the building block of the formula (S7-1) with a compound of a bifunctional agent of the formula (S7-3),
   Y1—B—Y2 (S7-3)
   where Y1 and Y2 are each a reactive group, to give a compound of the formula (S7-4): 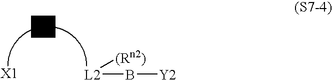
d) reaction of a compound of the formula (S7-4) with an agent which allows the introduction of L1 to form a compound of the formula (S7-5) 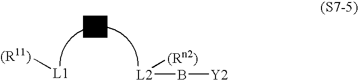
e) reaction of a compound of the formula (S7-5) with a compound of a functionalized building block of the formula (S7-2) to form a compound of the formula (S7-6) 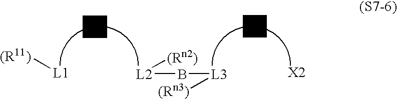
   and subsequent
f) reaction of a compound of the formula (S7-6) with an agent which allows the introduction of L4.

A further process for preparing compounds of the formula (VII) comprises the steps:
a) provision of a compound of a building block of the formula (S8-1), 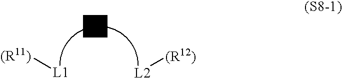
   where the index l1 corresponds to the number and the difference of the substituents of the group R and can have any value from 0 to α−1, where α corresponds to the valency of L1, and the index l2 corresponds to the number and the difference of the substituents of the group R and can have any value from 0 to β−1, where β corresponds to the valency of L2,
b) provision of a compound of a functionalized building block of the formula (S8-2), 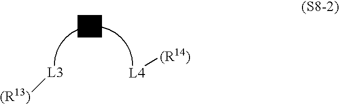
   where the index l3 corresponds to the number and the difference of the substituents of the group R and can have any value from 0 to γ−1, where γ corresponds to the valency of L3, and the index l4 corresponds to the number and the difference of the substituents of the group R and can have any value from 0 to δ−1, where δ corresponds to the valency of L4,
c) reaction of a compound of a building block of the formula (S8-1) with a compound of a bifunctional agent of the formula (S8-3),
   Y1—B—Y2 (S8-3)
   where Y1 and Y2 are each a reactive group, to a form a compound of the formula (S8-4), 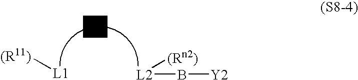
   where n2 is smaller than or equal to l2, and subsequent
d) reaction of a compound of the formula (S8-4) with a compound of a functionalized building block of the formula (S8-2).

A further process for preparing compounds of the formula (VII) comprises the steps:
a) provision of a compound of a building block of the formula (S9-1), 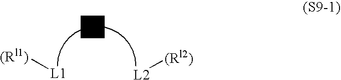
   where the index l1 corresponds to the number and the difference of the substituents of the group R and can have any value from 0 to α-1, where a corresponds to the valency of L1, and the index l2 corresponds to the number and the difference of the substituents of the group R and can have any value from 0 to β−1, where β corresponds to the valency of L2;
b) provision of a compound of a functionalized building block of the formula (S9-2), 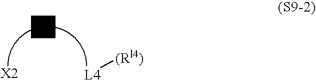
   where X2 is a reactive group and the index l4 corresponds to the number and the difference of the substituents of the group R and can have any value from 0 to δ−1, where δ corresponds to the valency of L4,
c) reaction of a compound of a building block of the formula (S9-1) with a compound of a bifunctional agent of the formula (S9-3) 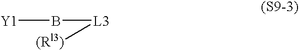
   to form a compound of the formula (S9-4), 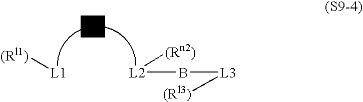
   where n2 is smaller than or equal to l2, and subsequent
d) reaction of a compound of the formula (S9-4) with a compound of a functionalized building block of the formula (S9-2).

A further process for preparing compounds of the formula (VD) comprises the steps:
b) provision of a compound of a building block of the formula (S10-1), 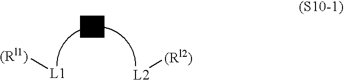
   where the index l1 corresponds to the number and the difference of the substituents of the group R and can have any value from 0 to α−1, where α corresponds to the valency of L1, and the index l2 corresponds to the number and the difference of the substituents of the group R and can have any value from 0 to β−1, where β corresponds to the valency of L2,
b) provision of a compound of a functionalized building block of the formula (S10-2), 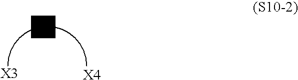
   where X3 and X4 are reactive groups,
c) reaction of a compound of a building block of the formula (S10-1) with a compound of a bifunctional agent of the formula (S10-3) 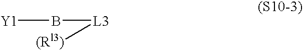
   to form a compound of the formula (S10-4), 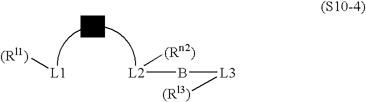
   where n2 is smaller than or equal to l2, subsequent
d) reaction of a compound of the formula (S10-4) with a compound of the formula (S10-2) to form a compound of the general formula (S10-5) 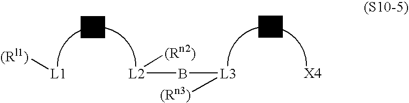
   and subsequent
g) reaction of a compound of the formula (S10-5) with an agent which allows the introduction of L4.

A further process for preparing compounds of the formula (VII) comprises the steps:
a) provision of a compound of a building block of the formula (S11-1), 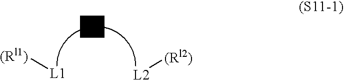
   where the index l1 corresponds to the number and the difference of the substituents of the group R and can have any value from 0 to α−1, where α corresponds to the valency of L1, and the index l2 corresponds to the number and the difference of the substituents of the group R and can have any value from 0 to β−1, where β corresponds to the valency of L2,
b) provision of a compound of a functionalized building block of the formula (S11-2), 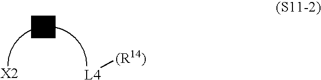
   where X2 is a reactive group and the index l4 corresponds to the number and the difference of the substituents of the group R and can have any value from 0 to δ−1, where 67 corresponds to the valency of L4,
c) reaction of a compound of the formula (S11-2) with a compound of a bifunctional agent of the formula (S11-3) 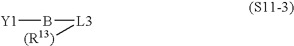
   to form a compound of the formula (S11-4), 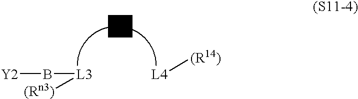
   where n3 is smaller than or equal to l3;
d) reaction of a compound of the formula (S11-4) with a compound of a functionalized building block of the formula (S11-2).

A further process for preparing compounds of the formula (VII) comprises the steps:
a) provision of a building block of the formula (S12-1), 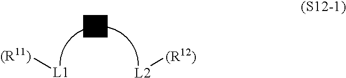
   where the index l1 corresponds to the number and the difference of the substituents of the group R and can have any value from 0 to α−1, where a corresponds to the valency of L1, and the index l2 corresponds to the number and the difference of the substituents of the group R and can have any value from 0 to β−1, where p corresponds to the valency of L2,
b) provision of a compound of a functionalized building block of the formula (S12-2), 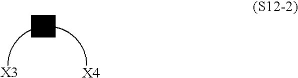
   where X3 and X4 are reactive groups;
c) reaction of a compound of a functionalized building block of the formula (S12-2) with a compound of a bifunctional agent of the formula (S12-3) 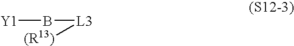
   to form a compound of the formula (S124), 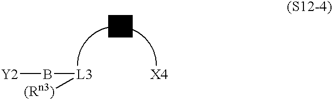
   where n3 is smaller than or equal to l3, subsequent
d) reaction of a compound of the formula (S12-4) with a compound of the formula (S12-1) to form a compound of the formula (S12-5) 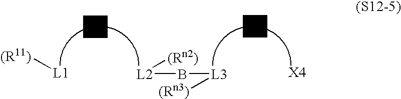
   and subsequent
e) reaction of a compound of the formula (S12-5) with an agent which allows the introduction of L4.

A further process for preparing compounds of type (VII) comprises the steps:
a) provision of a compound of a building block of the formula (S13-1), 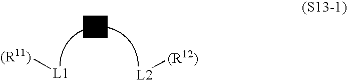
   where the index l1 corresponds to the number and the difference of the substituents of the group R and can have any value from 0 to α−1, where ax corresponds to the valency of L1, and the index l2 corresponds to the number and the difference of the substituents of the group R and can have any value from 0 to β−1, where β corresponds to the valency of L2,
b) provision of a compound of a functionalized building block of the formula (S13-2), 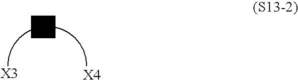
   where X3 and X4 are reactive groups,
c) reaction of a compound of a functionalized building block of the formula (S13-2) with a compound of a bifunctional agent of the formula (S13-3) 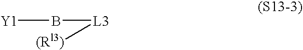
   to form a compound of the formula (S13-4), 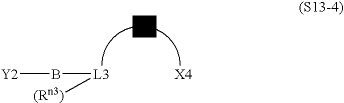
   where n3 is smaller than or equal to l3, subsequent
d) reaction of a compound of the formula (S13-4) with an agent which allows the introduction of L4 to form a compound of the formula (S13-5) 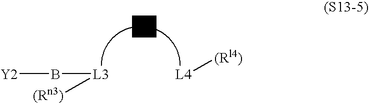
   and subsequent
e) reaction of a compound of the formula (S13-5) with a compound of the formula (S13-1).

Preference is given to a process for preparing compounds in which L3 and L4 are nitrogen atoms which comprises the steps
a) synthesis of an α-ketoimine or α-aldimine by reaction of an α,β-dicarbonyl compound with a primary amine in the presence or absence of a catalyst based on a compound of the type
   M₃(Q^{o3})
   and subsequent isolation of the product formed; where
   M₃ is a transition metal, boron, aluminium, silicon, germanium, an alkali metal or alkaline earth metal and
   the ligands Q are selected from the group consisting of monoanionic, dianionic and uncharged ligands and
   o3 can be 0, 1, 2, 3, 4, 5, 6, 7 or 8 depending on the charge on M₃;
b) reaction of the product from step a) with a diamine, in particular an aromatic diamine, and isolation of the product obtained and
c) reaction of the product from step b) with M₁(Q^{m1}) and/or M₂(Q^{m2}) and subsequent isolation of the product.

Particular preference is given to a process for preparing compounds of the type (V) which comprises the steps
a) synthesis of a α-ketoimine or α-aldimine by reaction of a α, β-dicarbonyl compound with a primary amine and subsequent isolation of the product formed;
b) reaction of the product from step a) with a diamine, in particular an aromatic diamine, in the presence of M₁(Q^{m1}) and/or M₂(Q^{m2}) and subsequent isolation of the product.

Very particular preference is given to a process for preparing compounds of the formula (V) which comprises the steps
a) synthesis of a compound of the formula (VIII) 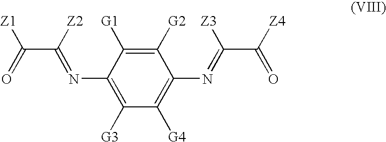
   by reaction of a para-phenylenediamine with 2 equivalents of a dicarbonyl compound in the presence or absence of a catalyst based on a compound of the type M₃(Q^{o3}), where
   M₃ is a transition metal, boron, aluminium, silicon, germanium, an alkali metal or alkaline earth metal and
   the ligands Q are selected from the group consisting of monoanionic, dianionic and uncharged ligands and
   o3 can be 0, 1, 2, 3, 4, 5, 6, 7 or 8 depending on the charge on M₁;
   and subsequent isolation of the product formed,
b) reaction of the product from step a) with a primary amine, in particular an aromatic amine, in the presence or absence of a catalyst based on a compound of the type M₄(Q^{o4}), where
   M⁴ is a transition metal, boron, aluminium, silicon, germanium, an alkali metal or alkaline earth metal and
   the ligands Q are selected from the group consisting of monoanionic, dianionic and uncharged ligands and
   o4 can be 0, 1, 2, 3, 4, 5, 6, 7 or 8 depending on the charge on M₁;
   and isolation of the product obtained;
c) reaction of the product from step b) with M₁(Q^{m1}) and/or M₂(Q^{m2}) and subsequent isolation of the product.

A special preference is given to a process for preparing compounds of the formula (V) which comprises the steps
a) synthesis of a compound of the formula (VIII) 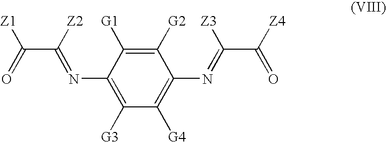
   by reaction of a para-phenylenediamine with 2 equivalents of a dicarbonyl compound in the presence or absence of a catalyst based on a compound of the type M₃(Q^{o3}), where
   M₃ is a transition metal, boron, aluminium, silicon, germanium, an alkali metal or alkaline earth metal and
   the ligands Q are selected from the group consisting of monoanionic, dianionic and uncharged ligands and
   o3 can be 0, 1, 2, 3, 4, 5, 6, 7 or 8 depending on the charge on M₁;
   reaction of the product from step a) with a diamine, in particular an aromatic diamine, in the presence of M₁(Q^{m1}) and/or M₂(Q^{m2}) and subsequent isolation.

The compounds of the invention are used as catalysts.

They are preferably used as catalyst in olefin-polymerization.

The compounds of the invention are particularly preferably used either alone or in combination with acids and bases such as Lewis acids, Brönstedt acids or Pearson acids or Lewis bases as catalysts for the homopolymerization, copolymerization und oligopolymerization of olefins.

Preferred Lewis acids are boranes or alanes such as aluminium alkyls, aluminium halides, alkylaluminium halides, aluminium alkoxides, boron organyls, boron halides, boric esters or boron or aluminium compounds which contain both halide and alkyl or aryl or alkoxide substituents or the triphenylmethyl cation, and also mixtures thereof.

Particular preference is given to aluminoxanes or mixtures of aluminium-containing Lewis acids with water and alkylaluminium halides, which are generally known to those skilled in the art.

In the presence of these acids or bases, the compounds of the invention form intermediates which can be prepared as active catalyst solution either before the actual polymerization or (in situ) in the presence of the monomers to be polymerized.

The catalysts of the invention are preferably used for the homopolymerization, copolymerization and/or oligopolymerization of olefinic monomers. For the purposes of the present invention, olefinic monomers are all olefinic monomers known to those skilled in the art. Preference is given to monomers selected from the group consisting of ethene, propene, 1-butene, 2-butene, isobutene, 1-pentene, 2-pentene, 1-hexene, 2-hexene, 3-hexene, 1-heptene, 1-octene, 1-decene, 1-dodecene, cyclopentene, norbornene, ethylidenenorbornene, styrene, p-methylstyrene, methyl acrylate, methyl methacrylate, vinyl acetate, acrylonitrile, methacrylonitrile and mixtures thereof. Particular preference is given to ethene, propene, 1-butene, 2-butene, 1-hexene, 1-octene and cyclopentene.

These monomers are preferably used for preparing homopolymers. Very particular preference is given to the polymerization of ethene, propene or 2-butene.

The polymers obtained are used for producing shaped bodies of all types by the customary methods known to those skilled in the art, for example extrusion, injection moulding, foaming, film blowing, calendering.

### EXAMPLES

### Example 1

### Bis(2,4,6-trimethylanilino)zinc chloride (Compound 1)

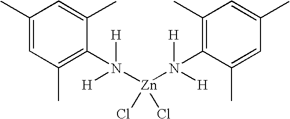

1.99 g of zinc chloride are suspended in 20 ml of toluene and admixed with 4.02 g of 2,4,6-trimethylaniline. The mixture is stirred for 20 minutes, and a further 20 ml of toluene are then added. After 35 minutes, 100 ml of n-hexane are added and the mixture is subsequently stirred for 1 hour. The product is filtered off and washed with 10 ml of toluene. It is subsequently dried to constant weight under reduced pressure.

Yield: 5.53 g (92%)

### Example 2

### Compound 2

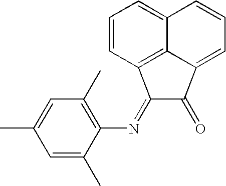

18.18 g of acenaphthoquinone and 61 mg of bis(2,4,6-trimethylanilino)zinc chloride are heated to 100° C. in an open round-bottomed flask with N₂ blanketing. 13.49 g of 2,4,6-trimethylaniline are then added and the mixture is heated at 160° C. for 1 hour. It is subsequently cooled to room temperature and admixed with 220 ml of dichloromethane. The mixture is filtered and the filtrate is evaporated to dryness on a rotary evaporator. The product is subsequently recrystallized from 300 ml of methanol.

Yield: 11.95 g (40%)

### Example 3

### Compound 3

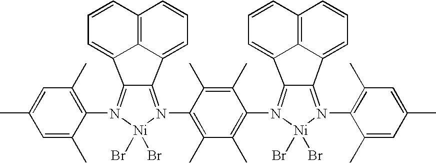

5.62 g of Compound 2, 1.24 g of 2,3,5,6-tetramethyl-para-phenylenediamine and 3.31 g of nickel dibromide are placed in a flask provided with a reflux condenser and admixed with 150 ml of glacial acetic acid. The mixture is refluxed for 2 days and then cooled and, after a further 4 days at room temperature, the product is filtered off. The filter residue is washed twice with 40 ml each time of glacial acetic acid and subsequently four times with 40 ml each time of diethyl ether and subsequently dried to constant weight in an oil pump vacuum.

Yield: 6.8 g (73%)

Ni content: 10.1% (calc.: 10.1%)

### Example 4

Polymerization of ethene, cocatalyst: methylaluminoxane (from Crompton GmbH/Bergkamen as 10% strength solution in toluene: Eurecen A15100/10T having a molar mass of 900 g/mol, CH3/Al: 1.97, hydrolysis gas: 85 standard ml/g, 5.2% m/m of Al, 34.2% m/m of TMA)

A 1 l autoclave which has been made inert is charged with 380 ml of toluene and 2.6 ml of a 10% strength solution of methylaluminoxane in toluene and heated to the polymerization temperature of 30° C. A pressure of 3.4 bar is then set by means of ethene and the solution is saturated with ethene.

7.6 mg of Compound 3 are dissolved in 32.6 ml of methylene chloride and 1 ml of this solution (corresponds to 0.233 mg) is then introduced into the reactor via a pressure burette. The pressure burette is rinsed with 20 ml of toluene to ensure transfer of the total amount of catalyst into the reactor. Polymerization is then carried out at a pressure of 3.4 bar. The pressure is regulated by introduction of ethene.

After 101 minutes, the experiment is stopped by interrupting the supply of ethene and transferring the contents of the reactor into a vessel containing 2 l of ethanol.

The polymer is filtered off and dried at 80° C. in a vacuum drying oven.

This gives 16.6 g of polyethylene, corresponding to a catalytic activity of 24 653 kg of polymer per mole of nickel and hour.

Melting point: 132° C. (DSC-2nd heating), enthalpy of fusion: 148 J/g

GPC: Mz: 1 516 000 Mw: 535 000 Mn: 183 000 Mw/Mn: 2.9

(The samples were each dissolved in ortho-dichlorobenzene (o-DCB) at 140° C. and measured using a high-temperature GPC instrument (Waters 150C) on a combination of 4 20 μm styrene-divinylbenzene linear columns (L=300 mm, d=8 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polyethylene at 140° C. in o-DCB.)

### Comparative Example 1

### Compound 4

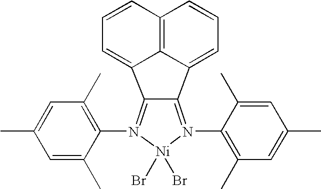

The nickel dibromide complex of acenaphthoquinone 2,4,6-trimethylphenylimine is synthesized as follows:

3.66 g of acenaphthoquinone and 4.37 g of nickel dibromide together with 75 ml of glacial acetic acid are placed in a reaction vessel and admixed with 5.41 g of 2,4,6-trimethylaniline under nitrogen atmosphere. The mixture is refluxed for 7.5 hours and then cooled. The precipitated product is washed twice with 30 ml each time of glacial acetic acid and four times with 25 ml of diethyl ether and subsequently dried to constant weight in an oil pump vacuum.

Yield: 10.4 g (78%)

Ni content: 9.0% (calc.:9.1%)

### Comparative Example 2

Polymerization of ethene, cocatalyst: methylaluminoxane (from Crompton GmbH/Bergkamen as 10% strength solution in toluene: Eurecen A15100/10T having a molar mass of 900 g/mol, CH3/Al: 1.97, hydrolysis gas: 85 standard nil/g, 5.2% m/m of Al, 34.2% m/m of TMA)

A 1 l autoclave which has been made inert is charged with 380 ml of toluene and 2.6 ml of a 10% strength solution of methylaluminoxane in toluene and heated to the polymerization temperature of 30° C. A pressure of 3.4 bar is then set by means of ethene and the solution is saturated with ethene.

14 mg of Compound 4 are dissolved in 54.9 ml of methylene chloride and 1 ml of this solution (corresponds to 0.255 mg) is then introduced into the reactor via a pressure burette. The pressure burette is rinsed with 20 ml of toluene to ensure transfer of the total amount of catalyst into the reactor. Polymerization is then carried out at a pressure of 3.4 bar. The pressure is regulated by introduction of ethene.

After 101 minutes, the experiment is stopped by interrupting the supply of ethene and transferring the contents of the reactor into a vessel containing 2 l of ethanol.

The polymer is filtered off and dried at 80° C. in a vacuum drying oven.

This gives 10.05 g of polyethylene, corresponding to a catalytic activity of 14 927 kg of polymer per mole of nickel and hour.

Melting point: 125° C. (DSC-2nd heating), enthalpy of fusion: 125 J/g

Comparison of the catalytic activity with that in Example 4 shows that the binuclear complex is significantly more active than the mononuclear complex.

### Example 5

Polymerization of Ethene, Cocatalyst: Ethylaluminium Sesquichloride (from Crompton GmbH/Berg-kamen)

A 1 l autoclave which has been made inert is charged with 380 ml of toluene and 0.4 ml of ethylaluminium sesquichloride and heated to the polymerization temperature of 30° C. A pressure of 3.4 bar is then set by means of ethene and the solution is saturated with ethene.

7.6 mg of Compound 3 are dissolved in 32.6 ml of methylene chloride and 1 ml of this solution (corresponds to 0.233 mg) is then introduced into the reactor via a pressure burette. The pressure burette is rinsed with 20 ml of toluene to ensure transfer of the total amount of catalyst into the reactor. Polymerization is then carried out at a pressure of 3.4 bar. The pressure is regulated by introduction of ethene.

After 90 minutes, the experiment is stopped by interrupting the supply of ethene and transferring the contents of the reactor into a vessel containing 2 l of ethanol.

The polymer is filtered off and dried at 80° C. in a vacuum drying oven.

This gives 9.6 g of polyethylene.

Melting point: 128° C., enthalpy of fusion: 101 J/g

GPC: Mz: 1 375 000 Mw: 550 000 Mn: 205 000 Mw/Mn: 2.7

(The samples were each dissolved in ortho-dichlorobenzene (o-DCB) at 140° C. and measured using a high-temperature GPC instrument (Waters 150C) on a combination of 4 20 μm styrene-divinylbenzene linear columns (L=300 mm, d=8 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polyethylene at 140° C. in o-DCB.)

### Example 6

Polymerization of ethene, cocatalyst: diethylaluminium chloride (from Crompton GmbH/Berg-kamen)

A 1 l autoclave which has been made inert is charged with 380 ml of toluene and 0.33 ml of a 20% strength diethylaluminium chloride solution and heated to the polymerization temperature of 30° C.

A pressure of 3.4 bar is then set by means of ethene and the solution is saturated with ethene. 7.6 mg of Compound 3 are dissolved in 32.6 ml of methylene chloride and 1 ml of this solution (corresponds to 0.233 mg) is then introduced into the reactor via a pressure burette. The pressure burette is rinsed with 20 ml of toluene to ensure transfer of the total amount of catalyst into the reactor. Polymerization is then carried out at a pressure of 3.4 bar. The pressure is regulated by introduction of ethene.

After 90 minutes, the experiment is stopped by interrupting the supply of ethene and transferring the contents of the reactor into a vessel containing 2 l of ethanol.

The polymer is filtered off and dried at 80° C. in a vacuum drying oven.

This gives 5.8 g of polyethylene.

Melting point: 137° C., enthalpy of fusion: 126 J/g

GPC: Mz: 2 316 000 Mw: 682 000 Mn: 209 000 Mw/Mn: 3.3

(The samples were each dissolved in ortho-dichlorobenzene (o-DCB) at 140° C. and measured using a high-temperature GPC instrument (Waters 150C) on a combination of 4 20 μm styrene-divinylbenzene linear columns (L=300 mm, d=8 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polyethylene at 140° C. in o-DCB.)

### Example 7

Polymerization of propene, cocatalyst: methylaluminoxane (from Crompton GmbH/Bergkamen as 10% strength solution in toluene: Eurecen A15 100/10T having a molar mass of 900 g/mol, CH₃/Al: 1.97, hydrolysis gas: 85 standard ml/g, 5.2% m/m of Al, 34.2% m/m of TMA)

A 1 l autoclave which has been made inert is charged with 380 ml of toluene and 26.4 ml of a 10% strength solution of methylaluminoxane in toluene and heated to the polymerization temperature of 30° C. A pressure of 6 bar is then set by means of propene and the solution is saturated with propene.

320 mg of Compound 3 are dissolved in 68.8 ml of methylene chloride and 5 ml of this solution (corresponds to 23.3 mg) are then introduced into the reactor via a pressure burette. The pressure burette is rinsed with 20 ml of toluene to ensure transfer of the total amount of catalyst into the reactor. Polymerization is then carried out at a pressure of 6 bar. The pressure is regulated by introduction of propene.

After 90 minutes, the experiment is stopped by interrupting the supply of propene and transferring the contents of the reactor into a vessel containing 2 l of ethanol.

The polymer is filtered off and dried at 80° C. in a vacuum drying oven.

This gives 10.2 g of polymer.

Glass transition temperature: −36° C. (DSC 2nd heating)

¹H-NMR (in C2D²Cl4 at 66° C.): 250 CH/1000C

GPC: Mz: 213 000 Mw: 132 000 Mn: δ 000 Mw/Mn: 2.4

(The samples were each dissolved in ortho-dichlorobenzene (o-DCB) at 140° C. and measured using a high-temperature GPC instrument (Waters 150C) on a combination of 4 20 μm styrene-divinylbenzene linear columns (L=300 mm, d=8 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polyethylene at 140° C. in o-DCB.)

### Example 8

Polymerization of propene, cocatalyst: methylaluminoxane (from Crompton GmbH/Bergkamen as 10% strength solution in toluene: Eurecen A151100/10T having a molar mass of 900 g/mol, CH₃/Al: 1.97, hydrolysis gas: 85 standard ml/g, 5.2% m/m of Al, 34.2% m/m of TMA)

A 1 l autoclave which has been made inert is charged with 380 ml of toluene and 26.4 ml of a 10% strength solution of methylaluminoxane in toluene and heated to the polymerization temperature of 30° C. A pressure of 3 bar is then set by means of propene and the solution is saturated with propene.

320 mg of Compound 3 are dissolved in 68.8 ml of methylene chloride and 5 ml of this solution (corresponds to 23.3 mg) are then introduced into the reactor via a pressure burette. The pressure burette is rinsed with 20 ml of toluene to ensure transfer of the total amount of catalyst into the reactor. Polymerization is then carried out at a pressure of 3 bar. The pressure is regulated by introduction of propene.

After 90 minutes, the experiment is stopped by interrupting the supply of propene and transferring the contents of the reactor into a vessel containing 2 l of ethanol.

The polymer is filtered off and dried at 80° C. in a vacuum drying oven.

This gives 10.4 g of polymer.

Glass transition temperature: −38° C. (DSC 2nd heating)

¹H-NMR (in C₂D₂Cl₄ at 76° C.): 262 CH/1000C

GPC: Mz: 126 000 Mw: 79 000 Mn: 40 000 Mw/Mn: 2.0

(The samples were each dissolved in ortho-dichlorobenzene (o-DCB) at 140° C. and measured using a high-temperature GPC instrument (Waters 150C) on a combination of 4 20 μm styrene-divinylbenzene linear columns (L=300 mm, d=8 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polyethylene at 140° C. in o-DCB.)

### Example 9

Polymerization of hexene, cocatalyst: methylaluminoxane (from Crompton GmbH/Bergkamen as 10% strength solution in toluene: Eurecen A15100/1 OT having a molar mass of 900 g/mol, CH₃/Al: 1.97, hydrolysis gas: 85 standard ml/g, 5.2% n/m of Al, 34.2% n/m of TMA)

A glass reactor which has been made inert is charged with 50 ml of toluene, 50 ml of 1-hexene and 26.4 ml of a 10% strength solution of methylaluminoxane in toluene.

320 mg of Compound 3 are dissolved in 68.8 ml of methylene chloride and 5 ml of this solution (corresponds to 23.3 mg) are then introduced into the reactor.

After 90 minutes, the experiment is stopped by transferring the contents of the reactor into a vessel containing 2 l of ethanol.

The polymer is filtered off and dried at 80° C. in a vacuum drying oven.

This gives 15.1 g of polymer.

Glass transition temperature: −54° C. (DSC 2nd heating)

¹H-NMR (in C₂D₂Cl₄ at 76° C.): 149 CH/1000C

GPC: Mz: 172 000 Mw: 99 000 Mn: 38 000 Mw/Mn: 2.6

(The samples were each dissolved in ortho-dichlorobenzene (o-DCB) at 140° C. and measured using a high-temperature GPC instrument (Waters 150C) on a combination of 4 20 μm styrene-divinylbenzene linear columns (L=300 mm, d=8 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polyethylene at 140° C. in o-DCB.)

### Example 10

Polymerization of 2-butene, cocatalyst: methylaluminoxane (from Crompton GmbH/Bergkamen as 10% strength solution in toluene: Eurecen A15100/10T having a molar mass of 900 g/mol, CH₃/Al: 1.97, hydrolysis gas: 85 standard ml/g, 5.2% m/m of Al, 34.2% m/m of TMA)

A glass reactor which has been made inert is charged with 100 ml of 1-hexane, 8.5 g of trans-2-butene and 12.1 ml of a 10% strength solution of methylaluminoxane in toluene.

187.8 mg of Compound 3 are dissolved in 40.3 ml of methylene chloride and 10 ml of this solution (corresponds to 46.6 mg) are then introduced into the reactor.

After 240 minutes, the experiment is stopped by admixing the contents of the reactor with 40 ml of ethanol and then washing twice with 100 ml each time of distilled water. The solvent is taken off on a rotary evaporator.

The polymer is dried at 80° C. in a vacuum drying oven.

This gives 6.4 g of polymer.

Glass transition temperature: −53° C. (DSC 2nd heating)

¹H-NMR (in C₂D₂Cl₄ at 76° C.): 247 CH/1000C

Mw: 216000 Mn: 187000 Mw/Mn: 1.15

(The samples were each dissolved in ortho-dichlorobenzene (o-DCB) at 40° C. and measured using a GPC instrument (Waters) on a combination of 3 20 μm styrene-divinylbenzene linear columns (L=300 mm, d=7.5 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polystyrene.)

### Comparative Example 3

Polymerization of 2-butene, cocatalyst: methylaluminoxane (from Crompton GmbH/Bergkamen as 10% strength solution in toluene: Eurecen A15100/10T having a molar mass of 900 g/mol, CH₃/Al: 1.97, hydrolysis gas: 85 standard ml/g, 5.2% m/m of Al, 34.2% m/m of TMA)

A glass reactor which has been made inert is charged with 100 ml of 1-hexane, 8.7 g of trans-2-butene and 12.1 ml of a 10% strength solution of methylaluminoxane in toluene.

43.8 mg of Compound 4 are dissolved in 10 ml of methylene chloride and of this solution is introduced into the reactor.

After 240 minutes, the experiment is stopped by admixing the contents of the reactor with 40 ml of ethanol and then washing twice with 100 ml each time of distilled water. The solvent is taken off on a rotary evaporator.

The polymer is dried at 80° C. in a vacuum drying oven.

This gives 4.4 g of polymer.

Glass transition temperature: −52° C. (DSC 2nd heating)

¹H-NMR (in C₂D₂Cl₄ at 76° C.): 247 CH/1000 C.

Mw: 231 000 Mn: 166 000 Mw/Mn: 1.39

(The samples were each dissolved in tetrahydrafuran at 40° C. and measured using a GPC instrument (Waters) on a combination of 3 20 μm styrene-divinylbenzene linear columns (L=300 mm, d=7.5 mm). Ionol served as internal standard for flow correction. A differential refractometer was used for detection of the polymer concentration in the eluate. Quantitative evaluation of the chromatograms was carried out on the basis of the concept of universal calibration with the aid of the Mark-Houwink parameters for polystyrene.)

1. Compounds of the formula (I), 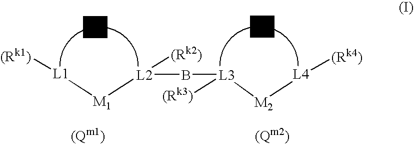
where
M₁ and M₂ can be identical or different and are selected independently from the group consisting of transition metals of groups 3 to l1 of the Periodic Table, Al and B and
L1, L2, L3, L4 can be identical or different and are selected independently from the group consisting of N, P, S, O, C, Si, Se, As and Sb and
A1 and A2 can be identical or different and are selected independently from among groups and/or atoms which can bridge the centres L1 to L2 and L3 to L4 via a covalent bond and can optionally contain further coordinating groups for M₁ and M₂ and
B is a group which electronically links the centres L2 and L3 to one another via covalent bonds and
m1 indicates the number and the difference of the individual ligands Q and can have any value from 1 to 6 and
m2 indicates the number and the difference of the individual ligands Q and can have any value from 1 to 6 and
Q is a group of from 1 to 6 ligands which are bound to M₁ and a group of from 1 to 6 ligands which are bound to M₂ where both the Q ligands which are bound to M₁ and the Q ligands which are bound to M₂ can be identical or different and are selected independently from the group consisting of monoanionic, dianionic and uncharged ligands, and
k1 indicates the number and the differences of the individual substituents R which are bound to L1 and can have any value from 0 to s¹−1, where s¹ is the valency of L1, and
k2 indicates the number and the differences of the individual substituents R which are bound to L2 and can have any value from 0 to s²−2, where s² is the valency of L2, and
k3 indicates the number and the differences of the individual substituents R which are bound to L3 and can have any value from 0 to s³−2, where s³ is the valency of L3, and
k4 indicates the number and the differences of the individual substituents R which are bound to L4 and can have any value from 0 to s⁴−1, where S4 is the valency of L4, and
R is a group of from 0 to s¹−1 substituents which are bound to L1, a group of from 0 to s²−2 substituents which are bound to L2, a group of from 0 to s³−2 substituents which are bound to L3 and a group of from 0 to s⁴−1 substituents which are bound to L4, where these can be identical or different and are selected independently from the group consisting of hydride, C₁₋₂₀-alkyl groups, C₁₋₂₀-alkenyl groups, C₅₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical, —OD¹, —ND²D³, PD⁶D⁷D⁸ and —BD⁹D¹⁰,
where D¹ to D¹⁰ can be identical or different and are selected independently from the group consisting of H, C₁₋₂₀-alkyl groups, C₅₋₂₀-cycloalkyl groups, C₆₋₂₀-aryl groups, alkylaryl groups having C₁₋₂₀ groups in the alkyl radical and C₆₋₂₀ groups in the aryl radical and arylalkyl groups having C₁₋₂₀ groups in the alkyl radical and C₆₋₂₀ groups in the aryl radical.

2. Compounds according to claim 1, wherein
L1, L2, L3 and L4 are identical or different and are selected independently from the group consisting of N, O, P and S.

3. Compounds of the formula (II) according to claim 1 or 2, 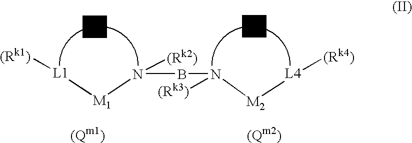
where L2 and L3 are nitrogen centres.

4. Compounds according to any of claims 1 to 3, wherein
A1 and A2 are identical or different and are selected independently from the group consisting of saturated or unsaturated hydrocarbon radicals having from 1 to 20 carbon atoms, cyclic saturated or unsaturated hydrocarbon radicals having from 4 to 20 carbon atoms, heterocyclic saturated or unsaturated compounds having from 3 to 20 carbon atoms, nitrogen-containing groups, phosphorus-containing groups, silicon-containing groups, tin-containing groups, germanium-containing groups and boron-containing groups, where all these groups may bear further substituents.

5. Compounds according to any of claims 1 to 4 in which B is an aromatic or heteroaromatic group which may bear further substituents.

6. Compounds of the formula (IV) according to any of claims 1 to 5, 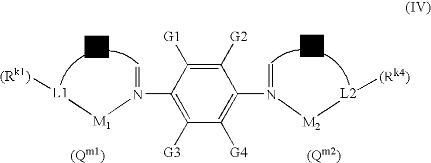
where L2 and L3 are nitrogen centres which are linked to A1 and A2 via a double bond and B is a para-substituted aromatic six-membered ring substituted by substituents
G1, G2, G3, G4 which are identical or different and selected from the group consisting of halide, hydride, C₁₋₂₀-alkyl groups, C₁₋₂₀-alkenyl groups, C₅₋₂₀-cycloalkyl groups, C₆₋₂₀-aryl groups, alkylaryl groups having C₁₋₂₀ groups in the alkyl radical and C₆₋₂₀ groups in the aryl radical, —OT¹, —OT¹T², —NT³T⁴, —NT⁵T⁶T⁷, —PT⁸T⁹, —PT¹⁰T¹¹T¹², where T¹ to T¹² are identical or different and are selected independently from the group consisting of H, C₁₋₂₀-alkyl groups, C₅₋₂₀-cycloalkyl groups, C₆₋₂₀-aryl groups, C₁₋₂₀-heteroaryl groups, alkylaryl groups having C₁₋₂₀ groups in the alkyl radical and C₆₋₂₀ groups in the aryl radical and arylalkyl groups having C₁₋₂₀ groups in the alkyl radical and C₆₋₂₀ groups in the aryl radical.

7. Compounds according to any of claims 1 to 6, wherein
L1 is identical to L4 and the unsubstituted skeleton of A1 is identical to the unsubstituted skeleton of A2.

8. Compounds according to any of claims 1 to 7, wherein
R^{k1} and R^{k4} are, respectively, a group of from 1 to s²−2 substituents which are bound to L1 and a group of from 1 to s⁴−2 substituents which are bound to L4, where these are identical or different and are selected independently from the group consisting of unsaturated C₆₋₂₀ cyclic systems which may bear further substituents, where the substituents can be identical or different and are selected independently from the group consisting of halide, hydride, C₁₋₂₀-alkyl groups, C₁₋₂₀-alkenyl groups, C₅₋₂₀-cycloalkyl groups, C₆₋₂₀-alkylaryl groups having C₁₋₂₀ groups in the alkyl radical and C₆₋₂₄ groups in the aryl radical, —OT¹, —OT¹T², —NT³T⁴, —NT⁵T⁶T⁷, —PT⁸T⁹ and —PT¹⁰T¹¹T¹² and two adjacent substituents may together form a saturated or unsaturated ring which may bear further substituents.

9. Compounds according to any of claims 1 to 8, wherein the substituents R of the groups R^{k1} and R^{k4} are in each case selected from the group consisting of substituted aryl and/or heteroaryl groups.

10. Compounds according to any of claims 1 to 9, wherein
M₁ and M₂ are identical or different and are selected independently from the group consisting of Ti, Zr, Hf, V, Cr, Mo, W, Mn, Fe, Ru, Co, Rh, Ni, Pd, Pt, Cu, Zn, Al and B,
Q is a group of from 1 to r₁−2 ligands which are bound to M₁ and a group of from 1 to r²−2 ligands which are bound to M₂, where both the Q ligands which are bound to M₁ and the Q ligands which are bound to M₂ are identical or different and selected independently from the group consisting of halide, hydride, C₁₋₁₀-alkyl groups, C₁₋₂₀-alkenyl groups, C₅₋₂₀-cycloalkyl groups, C₆₋₂₀-aryl groups, C₁₋₂₀-heteroaryl groups, alkylaryl groups having Cl ₂₀ groups in the alkyl radical and C₆₋₁₄ groups in the aryl radical, OT¹, OT¹T², —NT³T⁴, —NT⁵T⁶T⁷, —PT⁸T⁹, —PT¹⁰T¹¹T¹², 1,2-alkanediyl compounds, 1,4-alkanediyl compounds, 1,5-alkanediyl compounds, 1,ω-alkanediyl compounds, dialkoxides, dithiolates, diamides, ethers, amines, phosphines, phosphine oxides, olefins, acetylenes, carbon monoxide, nitrogen, hydrogen, carbenes, nitrogen ylides, carbon ylides and phosphorus ylides.

11. Compounds according to any of claims 1 to 10, wherein
M₁ and M₂ are identical or different and are selected independently from the group consisting of Ti, Zr, Hf, Fe, Ru, Co, Ni and Pd.

12. Compound of the formula (VI)

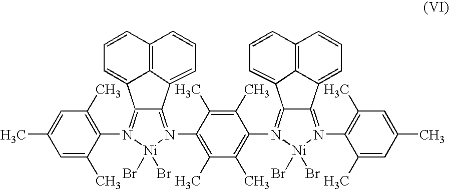

13. Process for preparing the compounds according to any of claims 1 to 12, which comprises the steps
a) preparation of a compound of the formula (VII), 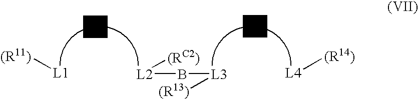
b) subsequent reaction of the compound of the formula (VII) either
I) with a metal compound of the formula M₁(Q^{m1}) and further reaction with a metal compound of the formula M₂(Q^{m2}) or
II) with a metal compound of the formula M₃(Q^{o3}), then reaction with a metal compound of the formula M₁(Q^{m1}) and further reaction with a metal compound of the formula M₂(Q^{m2}) or
III) with a metal compound of the formula M₁(Q^{m1}), then reaction with a metal compound of the formula M₃(Q^{o3}) and further reaction with a metal compound of the formula M₂(Q^{m2}) or
IV) with a metal compound of the formula M₃(Q^{o3}), then reaction with a metal compound of the formula M₁(Q^{m1}), then once again a reaction with a metal compound of the formula M₃(Q^{o3}) and further reaction with a metal compound of the formula M₂(Q^{m2}) or
V) with a plurality of metal compounds of the formula M₃(Q^{o3}), then reaction with a metal compound of the formula M₄(Q^{o4}), subsequent reaction with a metal compound of the formula M₁(Q^{m1}) and subsequent reaction with a metal compound of the formula M₂(Q^{m2}) or
VI) with a metal compound of the formula M₁(Q^{m1}), then reaction with a metal compound of the formula M₃(Q^{o3}), subsequent reaction with a metal compound of the formula M₄(Q^{o4}) and subsequent reaction with a metal compound of the formula M₂(Q^{m2}) or
VII) with a metal compound of the formula M₃(Q^{o3}), then reaction with a metal compound of the formula M₄(Q^{o4}), then reaction with a metal compound of the formula M₁(Q^{m1}), subsequently reaction again with a metal compound of the formula M₃(Q^{o3}), then reaction again with a metal compound of the formula M₄(Q^{o4}) and subsequent reaction with a metal compound of the formula M₂(Q^{m2}),
where o3 and o4 indicate the number and the differences of the individual ligands Q and are all values from 1 to 8 for the Q ligands which are bound to M₃ and are all values from 1 to 8 for the Q ligands which are bound to M₄ and M₃ and M₄ can be identical or different and are selected independently from the group consisting of transition metals of groups 3 to l1 of the Periodic Table, Al and B.

14. Use of the compounds according to any of claims 1 to 12 as catalysts.

15. Use of the compounds according to any of claims 1 to 12, wherein the compounds are reacted in the presence of acids or bases.

16. Intermediate obtainable by reacting one of the compounds according to any of claims 1 to 12 with an acid or a base.

17. Process for preparing homopolymers, copolymers and/or oligopolymers, wherein compounds according to any of claims 1 to 12 or intermediates according to claim 16 are reacted with olefinic monomers.

18. Process according to claim 17, wherein the olefinic monomers are selected from the group consisting of ethene, propene, 1-butene, 2-butene, isobutene, 1-pentene, 2-pentene, 1-hexene, 2-hexene, 3-hexene, 1-heptene, 1-octene, 1-decene, 1-dodecene, cyclopentene, norbornene, styrene, p-methylstyrene, methyl acrylate, methyl methacrylate, vinyl acetate, acrylonitrile and methacrylonitrile or mixtures thereof.

19. Polymers obtainable by the process according to claim 17 or 18.

20. Use of the polymers according to claim 19 for producing shaped parts of all types.

21. Shaped parts obtainable by processing of the polymers according to claim 19.
